(19) United States
(12) Patent Application Publication
(10) Pub. No.: US 2018/0268401 A1
(43) Pub. Date: Sep. 20, 2018

(54) SYSTEMS AND METHODS FOR HYBRID BLOCKCHAIN PLATFORM

(71) Applicant: ROYAL BANK OF CANADA, Montreal (CA)

(72) Inventors: Edison U. ORTIZ, Orlando, FL (US); Iustina-Miruna VINTILA, Bucharest (RO)

(21) Appl. No.: 15/923,310

(22) Filed: Mar. 16, 2018

Related U.S. Application Data
(60) Provisional application No. 62/473,186, filed on Mar. 17, 2017.

(51) Int. Cl. G06Q 20/36; G06Q 30/02

(52) U.S. Cl. CPC G06Q 20/3674; G06Q 30/0226

(57) ABSTRACT

There is provided a computer-implemented system for blockchain transaction settlement, the system including: a plurality of private nodes, each private node including at least one computing device and configured to maintain and update a private distributed ledger; and at least one communication interface between at least one of the plurality of private nodes and at least one public node of a plurality of public nodes which maintain and update a public distributed ledger. At least one private node may be configured for activities relating to the public nodes, such as receiving information, monitoring, verifications, among others.

### FIELD

The present disclosure generally relates to the field of computerized transaction processing, and more specifically, to the use of a distributed ledger and blockchain to process transaction settlement.

### INTRODUCTION

Transaction settlement is a process upon which performance metrics, security concerns, and ease of traversal are considerations that need to be factored into potential solutions. Various trade-offs may need to be made between each consideration, and the structure and architecture of a potential solution may aid in improving performance across one or more factors.

### SUMMARY

In accordance with an aspect, there is provided a computer-implemented system for blockchain transaction settlement. The system having a loyalty platform comprising: a plurality of private nodes, each private node including at least one computing device and configured to maintain and update a distributed ledger for loyalty points management; and an electronic wallet application having non-transitory computer-readable storage medium with computer-executable instructions for causing a processor of a mobile device to: store an electronic loyalty card token, the token linked to a customer identifier; receive a loyalty event notification indicating a loyalty event; transmit the loyalty event notification and the customer identifier to the loyalty platform; and the loyalty platform being configured to create a block for a loyalty transaction for the loyalty event notification using a private node, the block for the loyalty transaction indicating the customer identifier and the loyalty event, the loyalty platform being configured to maintain a loyalty account for the customer using the block.

In some embodiments, the loyalty platform is configured to maintain loyalty rules for calculating a loyalty point amount for the loyalty transaction for the loyalty event notification and store the loyalty point amount as part of the block for the loyalty transaction.

In some embodiments, the system has at least one communication interface between at least one of the plurality of nodes and at least one public node of a plurality of public nodes which maintain and update a public distributed ledger for clearing and settlement for transactions relating to loyalty points; wherein the loyalty platform is configured to receive a clearing and settlement notification for a transaction notification from the public distributed ledger; and transmit the loyalty event notification to the electronic wallet application.

In some embodiments, the transaction notification is linked to a merchant identifier and the loyalty platform is configured to use the merchant identifier for generating the block.

In some embodiments, the loyalty event notification is linked to a merchant identifier and the loyalty platform is configured to use the merchant identifier for generating the block.

In some embodiments, the system has an adaptor for communications between the electronic wallet application and the loyalty platform.

In some embodiments, the loyalty event is a earn event to earn loyalty points for a transaction, wherein the electronic wallet application is configured to: receive a transaction notification; wherein the loyalty platform is configured to receive a clearing and settlement notification for the transaction notification from the public distributed ledger; record an amount of loyalty points for the transaction notification as part of the block for the loyalty transaction.

In some embodiments, the electronic wallet application is configured to: receive a view loyalty point balance request; transmit a loyalty point balance request to the loyalty platform, the loyalty point balance request indicating the customer identifier; receive a loyalty point balance for the customer identifier from the loyalty platform; and initiate the display a loyalty point balance.

In some embodiments, the electronic wallet application is configured to: transmit payment authorization for the transaction notification.

In some embodiments, the electronic wallet application is configured to: transmit a view transaction history request to the loyalty platform, the loyalty point balance request indicating the customer identifier; receive transaction history data from the loyalty platform, the transaction history data generate from data on a plurality of blocks from the distributed ledger for loyalty points management, each of the plurality of blocks linked to the customer identifier.

In some embodiments, the loyalty event is a redeem event to redeem a number of loyalty points, the block for the loyalty transaction indicating a debit operation for the number of points from the loyalty account for the customer.

In some embodiments, the loyalty event is an exchange event to exchange a number of loyalty points into another currency, the block for the loyalty transaction indicating an exchange operation based on a configured conversion rate for the number of loyalty points.

In some embodiments, the loyalty event is a transfer event to transfer a number of loyalty points from the loyalty account to a target loyalty account, the block for the loyalty transaction indicating a debit operation for the number of loyalty points from the loyalty account and a credit operation for the number of loyalty points to the target loyalty account.

In some embodiments, the loyalty platform is configured to generate a loyalty profile for the customer identifier, the loyalty profile having a loyalty point balance and a transaction history, the loyalty profile being linked to a plurality of blocks in the distributed ledger for loyalty points management, each of the plurality of blocks indicating the customer identifier, a loyalty event and an amount of loyal points.

In some embodiments, the block comprises smart contract code for computing an amount of loyalty points for the loyalty transaction, the block indicating the amount of loyalty points.

In an aspect, there is provided an electronic wallet application with a non-transitory computer readable medium for blockchain transaction settlement storing instructions which when executed by a processor to: store an electronic loyalty card token, the token linked to a customer identifier; receive a loyalty event notification indicating the customer identifier and a loyalty event; transmit the loyalty event notification and the customer identifier to the loyalty platform; and the electronic wallet application exchanging data with an adaptor to a loyalty platform comprising: a plurality of private nodes, each private node including at least one computing device and configured to maintain and update a distributed ledger for loyalty points management; and the loyalty platform being configured to create a block for a loyalty transaction for the loyalty event notification using a private node, the block for the loyalty transaction indicating the customer identifier and the loyalty event, the loyalty platform being configured to maintain a loyalty account for the customer using the block.

In some embodiments, the loyalty platform is configured to maintain loyalty rules for calculating a loyalty point amount for the loyalty transaction for the loyalty event notification and store the loyalty point amount as part of the block for the loyalty transaction.

In some embodiments, there is at least one communication interface between at least one of the plurality of nodes and at least one public node of a plurality of public nodes which maintain and update a public distributed ledger for clearing and settlement for transactions relating to loyalty points; wherein the loyalty platform is configured to receive a clearing and settlement notification for a transaction notification from the public distributed ledger; and transmit the loyalty event notification to the electronic wallet application.

In some embodiments, the electronic wallet application of claim 18 wherein the transaction notification is linked to a merchant identifier and the loyalty platform is configured to use the merchant identifier for generating the block.

In some embodiments, the loyalty event notification is linked to a merchant identifier and the loyalty platform is configured to use the merchant identifier for generating the block.

In some embodiments, the loyalty event is a earn event to earn loyalty points for a transaction, wherein the electronic wallet application is configured to: receive a transaction notification; wherein the loyalty platform is configured to receive a clearing and settlement notification for the transaction notification from the public distributed ledger; record an amount of loyalty points for the transaction notification as part of the block for the loyalty transaction.

In some embodiments, the electronic wallet application is configured to: receive a view loyalty point balance request; transmit a loyalty point balance request to the loyalty platform, the loyalty point balance request indicating the customer identifier; receive a loyalty point balance for the customer identifier from the loyalty platform; and initiate the display a loyalty point balance.

In some embodiments, the electronic wallet application is configured to: transmit payment authorization for the transaction notification.

In some embodiments, the electronic wallet application is configured to: transmit a view transaction history request to the loyalty platform, the loyalty point balance request indicating the customer identifier; receive transaction history data from the loyalty platform, the transaction history data generate from data on a plurality of blocks from the distributed ledger for loyalty points management, each of the plurality of blocks linked to the customer identifier.

In some embodiments, the loyalty event is a redeem event to redeem a number of loyalty points, the block for the loyalty transaction indicating a debit operation for the number of points from the loyalty account for the customer.

In some embodiments, the loyalty event is an exchange event to exchange a number of loyalty points into another currency, the block for the loyalty transaction indicating an exchange operation based on a configured conversion rate for the number of loyalty points.

In some embodiments, the loyalty event is a transfer event to transfer a number of loyalty points from the loyalty account to a target loyalty account, the block for the loyalty transaction indicating a debit operation for the number of loyalty points from the loyalty account and a credit operation for the number of loyalty points to the target loyalty account.

In some embodiments, the loyalty platform is configured to generate a loyalty profile for the customer identifier, the loyalty profile having a loyalty point balance and a transaction history, the loyalty profile being linked to a plurality of blocks in the distributed ledger for loyalty points management, each of the plurality of blocks indicating the customer identifier, a loyalty event and an amount of loyal points.

In some embodiments, the block comprises smart contract code for computing an amount of loyalty points for the loyalty transaction, the block indicating the amount of loyalty points.

In an aspect, there is provided a computer-implemented system for blockchain transaction settlement. The system has a plurality of private nodes, each private node including at least one computing device and configured to maintain and update a private distributed ledger; and at least one communication interface between at least one of the plurality of private nodes and at least one public node of a plurality of public nodes which maintain and update a public distributed ledger.

The system can have at least one private node is configured for: receiving from a device associated with at least one of the public nodes, via the at least one communication interface, a notification message identifying a transaction for posting; monitoring at least one of the public nodes for an indication that the transaction has been cleared on the public distributed ledger; and upon obtaining the confirmation that the transaction has been cleared on the public distributed ledger, generating signals to initiate propagation of the transaction to the plurality of private nodes.

In some embodiments, at least one private node is configured for: receiving from a device associated with at least one of the private nodes, a notification message identifying a first transaction for posting; sending a notification message identifying the first transaction for posting to a second device associated with at least one of the public nodes; and generating signals to initiate propagation of the first transaction to the plurality of public nodes.

In some embodiments, the at least one private node is configured for: receiving a second notification message identifying a second transaction for posting; sending a notification message identifying the second transaction for posting to the second device associated with at least one of the public nodes; and generating signals to initiate propagation of a batch transaction to the plurality of public nodes, the batch transaction including a combination of the first and the second transactions.

In accordance with one aspect, there is provided a computer-implemented system for blockchain transaction settlement, the system comprising: a plurality of private nodes, each private node including at least one computing device and configured to maintain and update a private distributed ledger; and at least one communication interface between at least one of the plurality of private nodes and at least one public node of a plurality of public nodes which maintain and update a public distributed ledger.

In accordance with another aspect, at least one private node is configured for: receiving from a device associated with at least one of the public nodes, via the at least one communication interface, a notification message identifying a transaction for posting; monitoring at least one of the public nodes for an indication that the transaction has been cleared on the public distributed ledger; and upon obtaining the confirmation that the transaction has been cleared on the public distributed ledger, generating signals to initiate propagation of the transaction to the plurality of private nodes.

In accordance with another aspect, at least one private node is configured for: receiving from a device associated with at least one of the private nodes, a notification message identifying a first transaction for posting; sending a notification message identifying the first transaction for posting to a second device associated with at least one of the public nodes; and generating signals to initiate propagation of the first transaction to the plurality of public nodes.

In accordance with another aspect, the at least one private node is configured for: receiving a second notification message identifying a second transaction for posting; sending a notification message identifying the second transaction for posting to the second device associated with at least one of the public nodes; and generating signals to initiate propagation of a batch transaction to the plurality of public nodes, the batch transaction including a combination of the first and the second transactions.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a chart illustrating different axes for consideration when comparing platform architectures, according to some embodiments.

FIG. 2 is a comparison chart of a private distributed ledger network solution and a public distributed ledger network solution, according to some embodiments.

FIG. 3 is a block schematic diagram of a potential hybrid distributed ledger architecture, according to some embodiments.

FIG. 4 is a block schematic diagram of a second potential hybrid distributed ledger architecture utilizing a consensus layer operating between partners and FI internal private distributed ledger network solutions prior to clearance through a clearing and settlement platform that is a public distributed ledger network, according to some embodiments.

FIG. 5 is an example method for a customer loyalty points transaction earn-intra an organization, according to some embodiments.

FIG. 6 is an example method for a customer loyalty points transaction earn-inter organizations, according to some embodiments.

FIG. 7 is an example method for a customer loyalty points transaction redemption-intra an organization, according to some embodiments.

FIG. 8 is an example method for a customer loyalty points transaction redemption-inter organizations, according to some embodiments.

FIG. 9 is an example method for a customer loyalty points transaction transfer-intra an organization, according to some embodiments.

FIG. 10 is an example method for a customer loyalty points transaction transfer-inter organizations, according to some embodiments.

FIG. 11 illustrates a schematic of a computing device 1100 according to some embodiments.

FIG. 12A and FIG. 12B illustrates an example schematic diagram of a loyalty platform.

FIG. 13 illustrates an example architecture diagram of loyalty platform.

FIG. 14A and FIG. 14B illustrates an example system context diagram for loyalty platform

FIG. 15A, FIG. 15B and FIG. 15C illustrates an example architecture diagram of a loyalty platform

FIG. 16A and FIG. 16B illustrates a data model 1600 diagram for the loyalty platform

FIG. 17 illustrates a security application architecture for loyalty platform.

FIG. 18 illustrates a process for a loyalty program and relates to the Client with Merchant Loyalty.

FIG. 19 is a process for a loyalty program and can relate to the Retrieve Client Merchant Loyalty API.

FIG. 20A and FIG. 20B illustrates an example process for the loyalty program and relates to the Earn Merchant Loyalty Points API.

FIG. 21A and FIG. 21B illustrates an example process for a loyalty program that relates to Redeem Merchant Loyalty Points API.

FIG. 22A and FIG. 22B shows an example process for loyalty programs.

FIG. 23 illustrates a process with the Issue Merchant points in the Loyalty platform.

FIG. 24 is a process for the API View Merchant balances.

FIG. 25 is a process for the API Retrieve Merchant exchange rate.

FIG. 26A and FIG. 26B shows a process for the API Exchange Merchant points in the Loyalty platform.

### DETAILED DESCRIPTION

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, one or more public blockchain networks are utilized for network management, node management, and rewards partner on-boarding. A hybrid solution involving the use of a combination of one or more public blockchain networks and one or more private blockchain networks co-operating (e.g., working in tandem, in communication with one another) is provided, in some embodiments.

Some of the described embodiments are designed, among others, to increase convenience for participants (e.g., merchants) to interact with a platform, on-board, and reconcile their transactions, while managing procedural and technical issues that arise with widely distributed ledger implementations.

Blockchains and distributed ledger technology have been utilized to cooperatively create robust, decentralized networks that are used in various contexts, such as providing alternative currencies (crypto-currencies), smart contracts, proof of existence, among others.

In a typical distributed ledger, a plurality of nodes are employed that in communication with one another in storing and maintaining replicated ledgers that are synchronized and spread geographically across various locations, devices, institutions, etc. The robustness of the system is derived from the propagation of transactions that are posted against the records kept on the distributed ledger, and various propagation rules (e.g., consensus rules) are applied and maintained at each of the computing nodes having a distributed ledger that control how, when, if, etc. a transaction is added to the distributed ledger. The more nodes in a system and the less correlated the nodes are, the more robust the system becomes as it becomes more difficult for a single party or even a coordinated group of parties to perform unauthorized modifications to transactions recorded on the distributed ledger.

For example, with respect to cryptocurrencies, consensus rules are utilized to determine whether a transaction is authorized, and the way in which transaction records are propagated determine how a transaction is ultimately recorded on the distributed ledger. These propagation rules, for example, may be adapted to account for double spending attempts through the use of majority determinations and time codes, etc. The rules are of particular importance as without a centralized authority, the group of nodes as a whole and their distributed ledgers must substitute as the authority. Double spending, for example, can be overcome by waiting for a minimum number of confirmations on distributed ledgers on unrelated nodes such that there is evidence that a particular transaction has been recorded widely on the distributed ledgers (and is thus more likely to have been accepted and less vulnerable to race attacks).

Accordingly, the distributed ledger and its information become a trustworthy source of information that is typically not controlled by a single party. However, as the number of nodes decrease or nodes fall under the control of a single party, it becomes more easy for malicious parties to modify the transaction record (e.g., in the context of Bitcoin, a majority attack may be initiated by a party controlling more than half of the network hash rate, allowing the party to generate new transaction blocks into an otherwise honest network).

On the other hand, the additional of nodes increases the complexity of the system, and propagation becomes more complex and may require a greater duration of time.

Propagation of updates to transaction records to large scale numbers of nodes may cause major slowdowns. A total number of operations (e.g., queries) and transaction load on the distributed ledgers may also lead to slowdowns and productivity decreases.

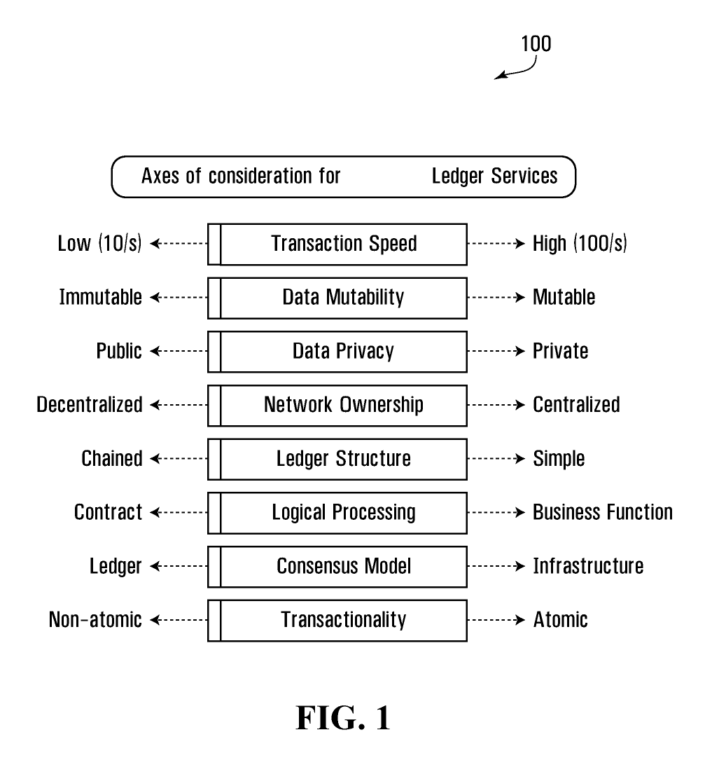

A hybrid approach is described in some embodiments, where a public distributed ledger network (e.g., Ethereum™ public network) is utilized alongside a private distributed ledger network (e.g., a private rewards ledger infrastructure). FIG. 1 is a chart 100 illustrating different axes for consideration when comparing platform architectures, according to some embodiments.

The public and the private ledgers may interoperate with one another, for example, for reconciliation (e.g., to ensure that the records are ultimately mirrors of one another), for integrity validation (e.g., to ensure that records are not corrupt or that an unexpected fork has occurred), or when there are synchronization problems internally within one of the networks and a backup distributed ledger process is necessary.

Blockchains are examples of overall data structures that can be stored on the distributed ledger, and each blockchain is made of blocks (or other data structures/containers) that are operatively linked to one another. These blocks can be cryptographically linked so that validation of downstream/upstream blocks by using upstream/downstream blocks is possible. Cryptographic linkages may be utilized so that non authorized individuals are unable to access information stored on the blockchain. These cryptographic linkages may utilized in various ways, such as providing the blocks in the form of a Merkle Tree (for ease of validation), utilize linkages generated through the use of cascaded hashing, etc.

The specific data structures in use and their selection for storage on the distributed ledgers may also have an impact on the performance of the distributed ledger itself. For example, different types of data structures have differing levels of security, ease of transaction, ease of traversal, etc.

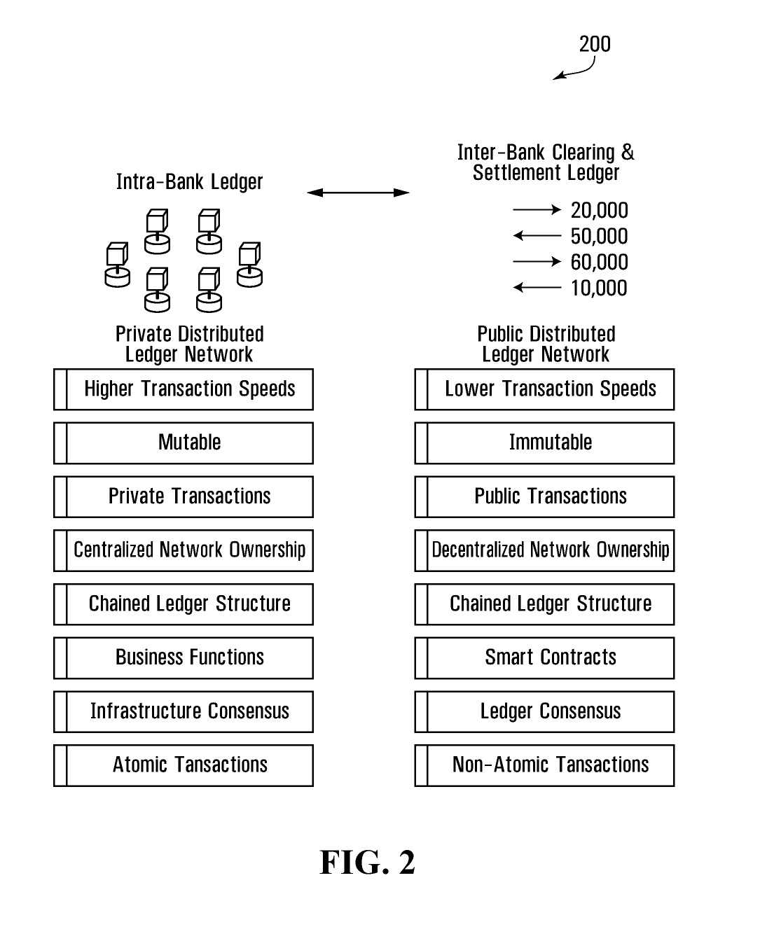

There may be very different needs and configurations between publicly available ledgers using untrusted, ad-hoc nodes, and private ledgers that are utilized among a secure set of trusted nodes. FIG. 2 is a comparison chart 200 of a private distributed ledger network solution and a public distributed ledger network solution, according to some embodiments.

As described in some embodiments, a hybrid model of public and private distributed ledgers and blockchain is proposed that utilizes one or more public distributed ledger networks in cooperation with one or more private ledger networks. While the hybrid model may result in some duplicated and redundant storage, different parts of the hybrid model may be tuned for specific purposes and configured for specific advantages and to minimize the impact of specific disadvantages. For example, a publicly available blockchain network can be utilized to store a mirrored set of transaction blocks with a privately available blockchain network. In doing so, transactions and actions that are more efficiently conducted or have improved characteristics on one of the networks can be done on that network instead.

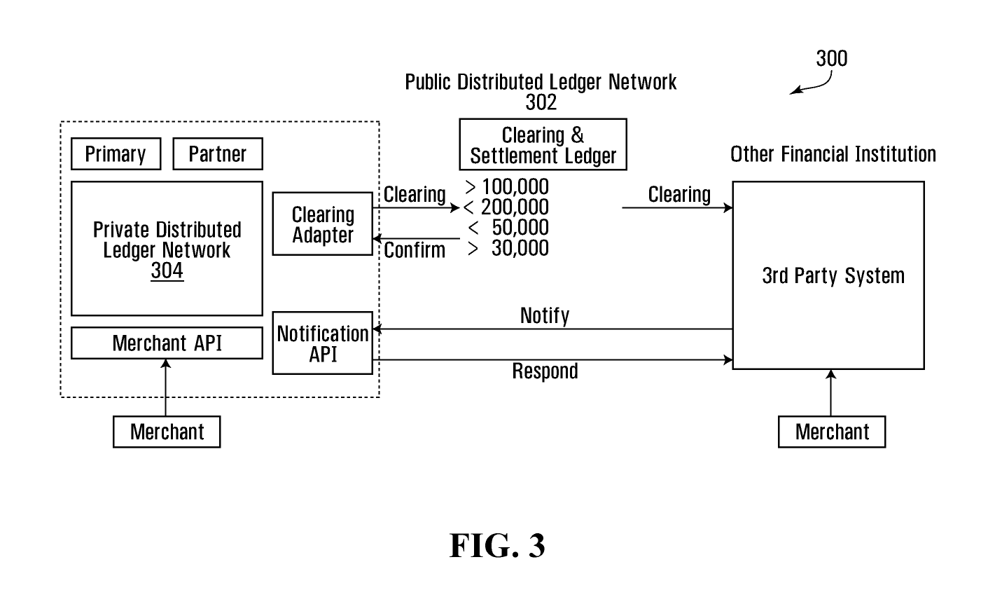

FIG. 3 is a block schematic diagram 300 of a potential hybrid distributed ledger architecture, according to some embodiments.

In the example architecture of FIG. 3, a private distributed ledger network 304 is utilized in combination with a public distributed ledger network 302. The network includes a computer-implemented system for blockchain transaction settlement, and the blocks represent private nodes that each may include, for example at least one computing device and configured to maintain and update a private distributed ledger. There may be a communication interface established between at least one of the plurality of private nodes and at least one public node of a plurality of public nodes which maintain and update a public distributed ledger.

The public distributed ledger network 302 is utilized for clearing and settlement, and the two ledgers networks interact by way of clearing adaptor. Communications are provided with a third party system (e.g., located at another financial institution), and these communications may include, among others, notifications, responses, provided via a notification application programming interface (API).

Depending on the architecture, the hybrid model may include master/slave dichotomies, where a set of nodes or a network can be associated with a higher level of trust or authenticity, in accordance, for example, based on different trust models and permissions for actions, among others (e.g., redundancy characteristics, improved security).

To receive and/or process transaction information, private nodes may be configured to receive from a device associated with at least one of the public nodes, via the at least one communication interface, a notification message identifying a transaction for posting; and to monitor at least one of the public nodes for an indication that the transaction has been cleared on the public distributed ledger. Upon obtaining the confirmation that the transaction has been cleared on the public distributed ledger network, signals may be generated to initiate propagation of the transaction to the plurality of private nodes. There may be batch transaction processing of multiple transactions, etc.

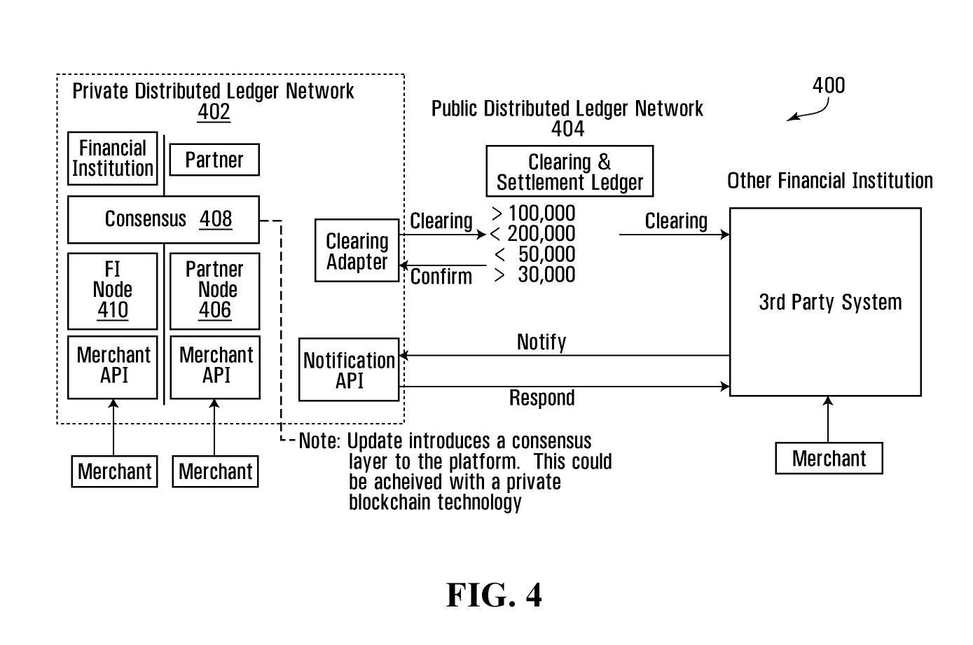

FIG. 4 is a block schematic diagram 400 of a second potential hybrid distributed ledger architecture utilizing a consensus layer operating between partners and FI internal private distributed ledger network 402 implementation prior to clearance through a clearing and settlement platform that is a public distributed ledger network 404, according to some embodiments.

In an example context of a rewards processing hybrid system, partners may be onboarded by way of a public network (e.g., Ethereum™), and provided with identities and access to rewards functions. In the example of FIG. 4, trusted partner nodes 406 may be part of the private distributed ledger network 402 along with financial institution nodes 410. A consensus layer 408 may be applied for distributing ledgers and maintaining ledgers across the private distributed ledger network 402. A merchant API enables merchant devices to interact with the trusted partner nodes 406 and financial institution nodes 410.

In some embodiments, the various partners may have different trust models, and/or permissions for their actions. The public distributed ledger network 404 may be more apt for transaction requests, for example, fulfilling a rewards function.

A tuned public distributed ledger network 404 may be configured for increased speed and traversal, based on activities being performed on it. However, there may be a decreased level of cyber-security or validation, increasing the risk, for example, of a double spending attack being launched at the public distributed ledger or its nodes.

A private distributed ledger network 402 may be mirrored (e.g., become a proxy) of the public distributed ledger network 404, and different or alternate rules may be applied in relation to the private distributed ledger network 402.

As the nodes (e.g. partner nodes 406, financial institution nodes 410) for the private distributed ledger network 402 are likely a smaller number of trusted nodes, the corresponding blockchain structure may have improvements in processing, update, and maintenance.

The public distributed ledger network 404 and the private distributed ledger network 402 may operate in conjunction with one another to perform different tasks. For example, a public distributed ledger network 404 (e.g., Ethereum™) can perform minimal validation for the transaction, and then it will be forwarded to the private distributed ledger network 402 (e.g., a rewards ledger stored at one or more financial institutions). Architectural components may be provided whereby identity management is a consideration, and recovery of lost keys. For example, in a trusted private distributed ledger network 402, keys may be designed to be recoverable, and transactions may be ultimately mutable as, in some embodiments, the only nodes (e.g. partner nodes 406, financial institution nodes 410) allowed to access the private distributed ledger network 404 are trusted nodes.

A hybrid public/private distributed ledger network 404, 402 solution may provide improvements that address deficiencies of using only a public distributed ledger network 404 or a private distributed ledger network 402 by itself. For example, public distributed ledger networks can include limitations, for example, latency issues, transaction volumes, transaction writing performance, public visibility of information written to the distributed ledger.

A private distributed ledger network 402 can be utilized, for example, to keep individual transaction details private, and the public distributed ledger network can be used in conjunction to allow certain elements of information, such as an aggregate loyalty point position, to be publicly available.

The advantages of solutions using both public/private distributed ledger network 404, 402 can be obtained and some of the weaknesses mitigated. However, the communication and cooperation between the public/private distributed ledger network 404, 402 adds a level of overhead into the system. For example, there may be considerations around how ledgers and information are updated as between the public/private distributed ledger network 404, 402, what happens in the event of a conflict, and which of the public/private distributed ledger network 404, 402 is paramount in the event of a conflict.

### Loyalty Points Transaction Earn-Intra

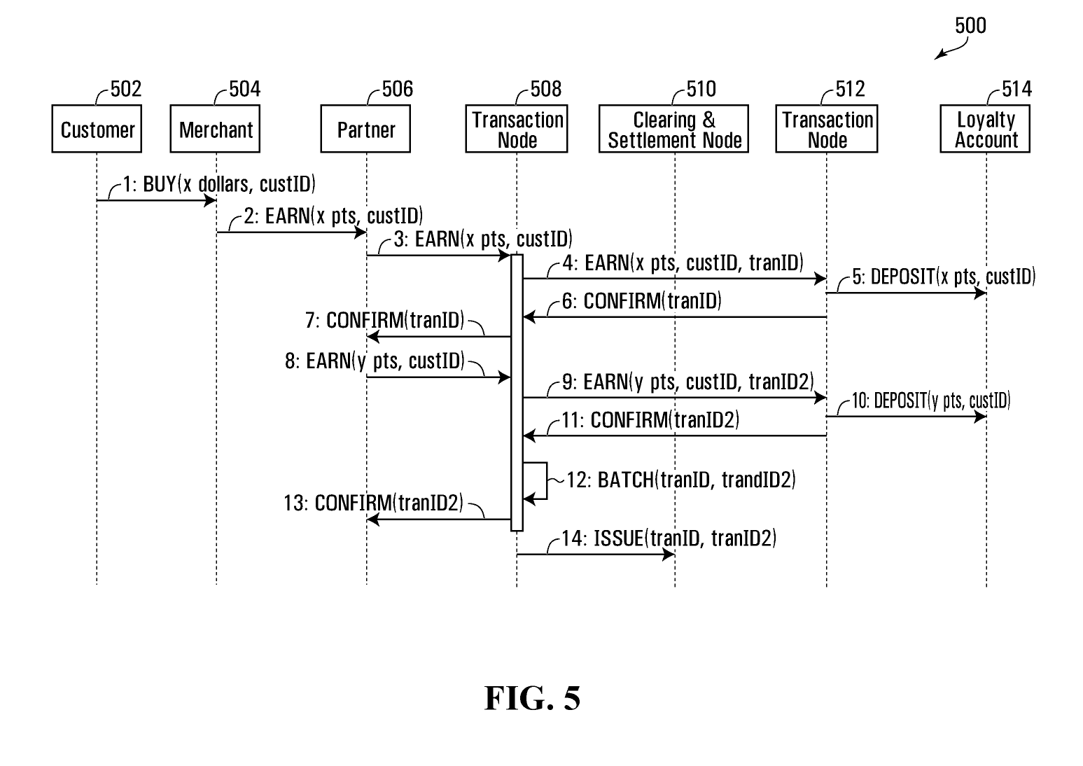

FIG. 5 is an example method 500 for a customer loyalty points transaction earn-intra an organization, according to some embodiments. In this method, customer 502 earns loyalty points via a merchant 504 with a relationship with a Partner organization 506. Each transaction is deposited in the customer's Loyalty Account when earned with the batching and issuance to the Decentralized Blockchain at a later time. The transaction data can be recorded on the distributed ledger networks 404, 402. The customer 502 and the merchant 504 generate a buy transaction record that includes data such as item identifiers, transaction cost, customer identifier, transaction identifier, and so on. The data can be provided to loyalty system via merchant API, for example. The merchant 504 notifies the partner 506 of an earn transaction linked to the buy transaction. The earn transaction record includes data such as an amount of loyalty points and the customer identifier, along with transaction details and a transaction identifier. The earn transaction record (e.g. amount of loyalty points, the customer identifier, transaction identifier or tranID) can be provided from the partner 506 to transaction nodes 508, 512. A deposit transaction record (e.g. amount of loyalty points, the customer identifier, transaction identifier) can be provided by the transaction node 512 to the customer's loyalty account 514. A confirmation record (e.g. transaction identifier) for the deposit transaction record is provided by the transaction node 512 to the other transaction node 508 by way of the clearing and settlement node 510. The transaction node 508 provides the confirmation record (e.g. transaction identifier) to the partner 506.

The partner 506 provides another earn transaction record (e.g. amount of loyalty points, the customer identifier, another transaction identifier or tranID2) to transaction nodes 508, 512. A deposit transaction record (e.g. amount of loyalty points, the customer identifier, the other transaction identifier) can be provided by the transaction node 512 to the customer's loyalty account 514. A confirmation record (e.g. the other transaction identifier) for the deposit transaction record is provided by the transaction node 512 to the other transaction node 508 by way of the clearing and settlement node 510. A batch tool records all transaction identifiers (e.g. tranID, tranID2) to the private distributed ledger network 402, for example. The transaction node 508 provides the confirmation record (e.g. the other transaction identifier) to the partner 502. The transaction node 508 issues the transactions (e.g. tranID, tranID2) to the clearing and settlement node 510. The public distributed ledger network 404 can manage the clearing and settlement node 510, for example.

### Loyalty Points Transaction Earn-Inter

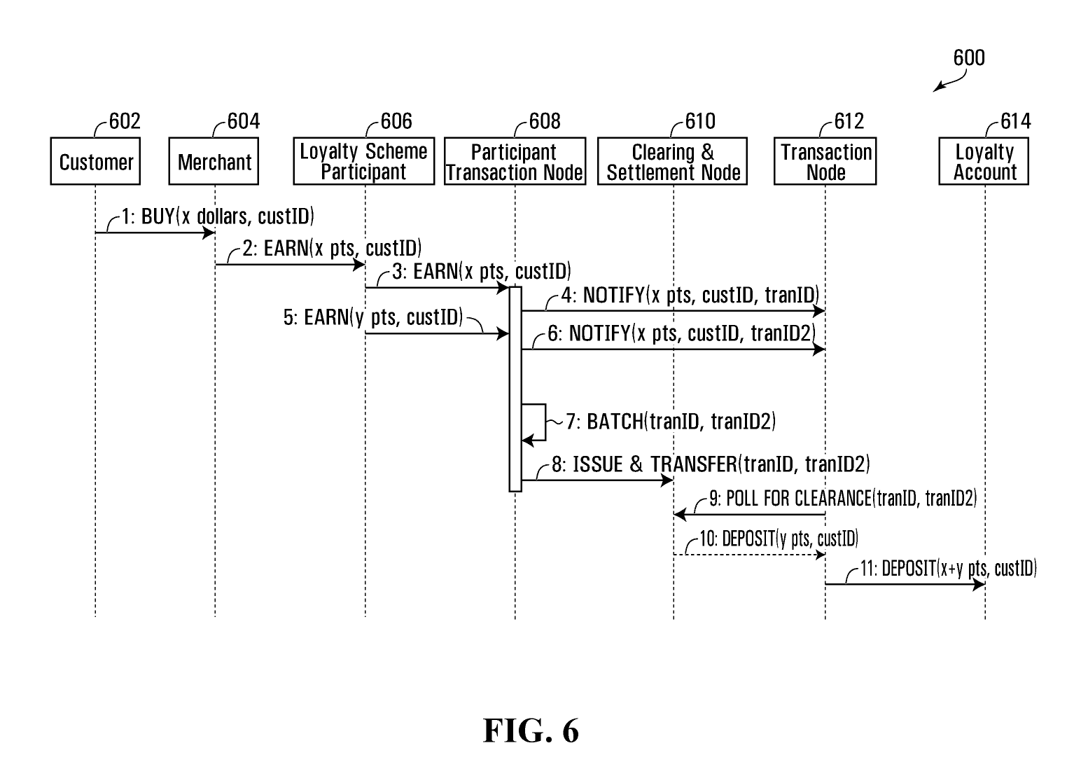

FIG. 6 is an example method 600 for a customer loyalty points transaction earn-inter organizations, according to some embodiments. In this method, the customer earns loyalty points via a merchant with a relationship with a Loyalty Scheme Participant. The financial institution (FI) is notified of each transaction of points earned. The Loyalty Scheme partner batches a number of transactions and issues to the Decentralized Blockchain. FI will poll the Blockchain and will deposit the points to the Loyalty Account when they have determined that the transactions have been issues to the Blockchain.

The transaction data can be recorded on the distributed ledger networks 404, 402. The customer 602 and the merchant 604 generate a buy transaction record that includes data such as item identifiers, transaction cost, customer identifier, transaction identifier, and so on. The data can be provided to loyalty system via merchant API, for example. The merchant 504 notifies the loyalty scheme participant 606 of an earn transaction linked to the buy transaction. The earn transaction record includes data such as an amount of loyalty points and the customer identifier, along with transaction details and a transaction identifier. The earn transaction record (e.g. amount of loyalty points or x points, the customer identifier, transaction identifier or tranID) can be provided from the loyalty scheme participant 606 to the participant transaction node 608. The participant transaction node 608 transmits a notify record (e.g. amount of loyalty points or x points, the customer identifier, transaction identifier or tranID) to the transaction node 612. Another earn transaction record (e.g. amount of loyalty points or y points, the customer identifier, another transaction identifier or tranID2) can be provided from the loyalty scheme participant 606 to the participant transaction node 608. The participant transaction node 608 transmits another notify record (e.g. amount of loyalty points or y points, the customer identifier, transaction identifier or tranID2) to the transaction node 612.

A batch tool records all transaction identifiers (e.g. tranID, tranID2) to the private distributed ledger network 402, for example. The participant transaction node 608 issues and transfers the transactions (e.g. tranID, tranID2) to the clearing and settlement node 610. The public distributed ledger network 404 can manage the clearing and settlement node 610, for example. The transaction node 612 polls the clearing and settlement node 610 for clearance of the transactions (e.g. tranID, tranID2). The clearing and settlement node 610 transmits a cleared notification for the transactions (e.g. tranID, tranID2) to the transaction node 612.

A deposit transaction record (e.g. amount of loyalty points, the customer identifier, transaction identifier) can be provided by the transaction node 612 to the customer's loyalty account 614.

### Loyalty Points Transaction Redeem-Intra

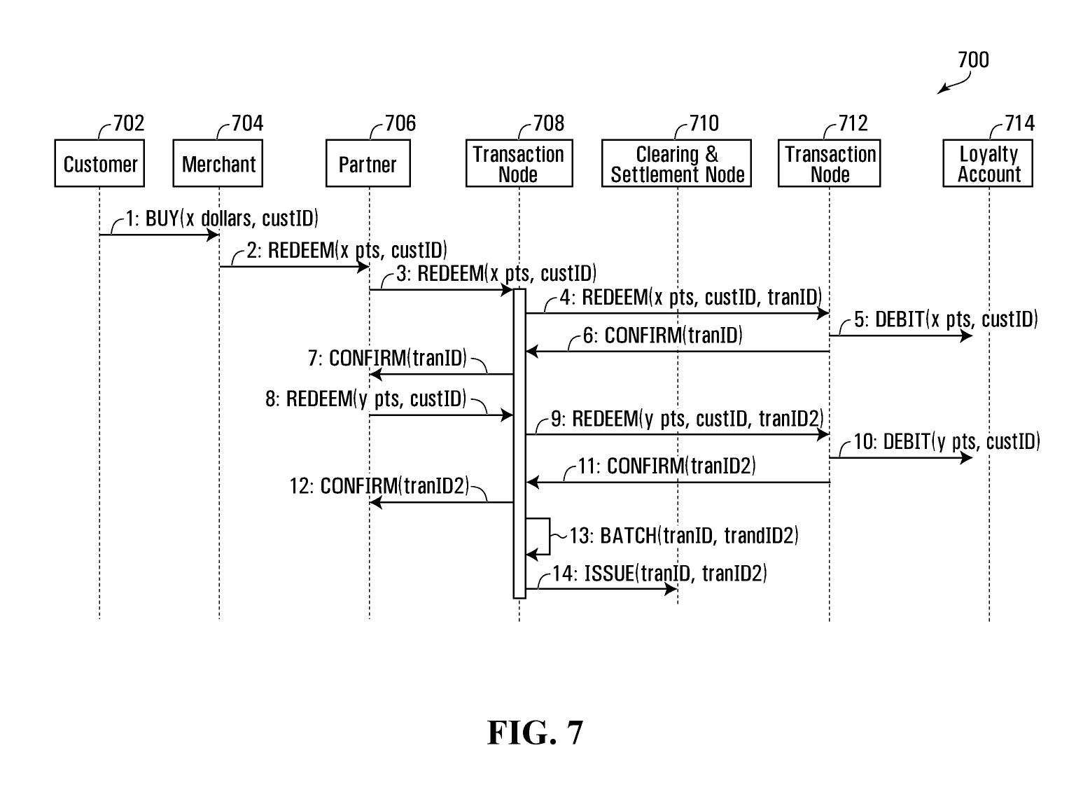

FIG. 7 is an example method 700 for a customer loyalty points transaction redemption-intra an organization, according to some embodiments. The customer may redeem loyalty points via a merchant with a relationship with a Partner organization. Each transaction is debited in the customer's Loyalty Account when redeemed with the batching and issuance to the Decentralized Blockchain at a later time.

The transaction data can be recorded on the distributed ledger networks 404, 402. The customer 702 and the merchant 704 generate a buy transaction record that includes data such as item identifiers, transaction cost, customer identifier, transaction identifier, and so on. The data can be provided to loyalty system via merchant API, for example. The merchant 704 notifies the partner 706 of a redeem transaction linked to the buy transaction. The redeem transaction record includes data such as an amount of loyalty points and the customer identifier, along with transaction details. The redeem transaction record (e.g. amount of loyalty points or x points, the customer identifier, transaction identifier or tranID) can be provided from the partner 706 to transaction nodes 708, 712. A debit transaction record (e.g. amount of loyalty points, the customer identifier, transaction identifier) can be provided by the transaction node 712 to the customer's loyalty account 714. A confirmation record (e.g. transaction identifier) for the debit transaction record is provided by the transaction node 712 to the other transaction node 708 by way of the clearing and settlement node 710. The transaction node 708 provides the confirmation record (e.g. transaction identifier) to the partner 706.

The partner 706 provides another redeem transaction record (e.g. amount of loyalty points or y points, the customer identifier, another transaction identifier or tranID2) to transaction nodes 708, 712. Another debit transaction record (e.g. amount of loyalty points, the customer identifier, the other transaction identifier) can be provided by the transaction node 712 to the customer's loyalty account 714. Another confirmation record (e.g. the other transaction identifier) for the other debit transaction record is provided by the transaction node 712 to the other transaction node 708 by way of the clearing and settlement node 710. A batch tool records all transaction identifiers (e.g. tranID, tranID2) to the private distributed ledger network 402, for example. The transaction node 708 provides the confirmation record (e.g. the other transaction identifier) to the partner 702. The transaction node 708 issues the transactions (e.g. tranID, tranID2) to the clearing and settlement node 710. The public distributed ledger network 404 can manage the clearing and settlement node 710, for example.

### Loyalty Points Transaction Redeem-Inter

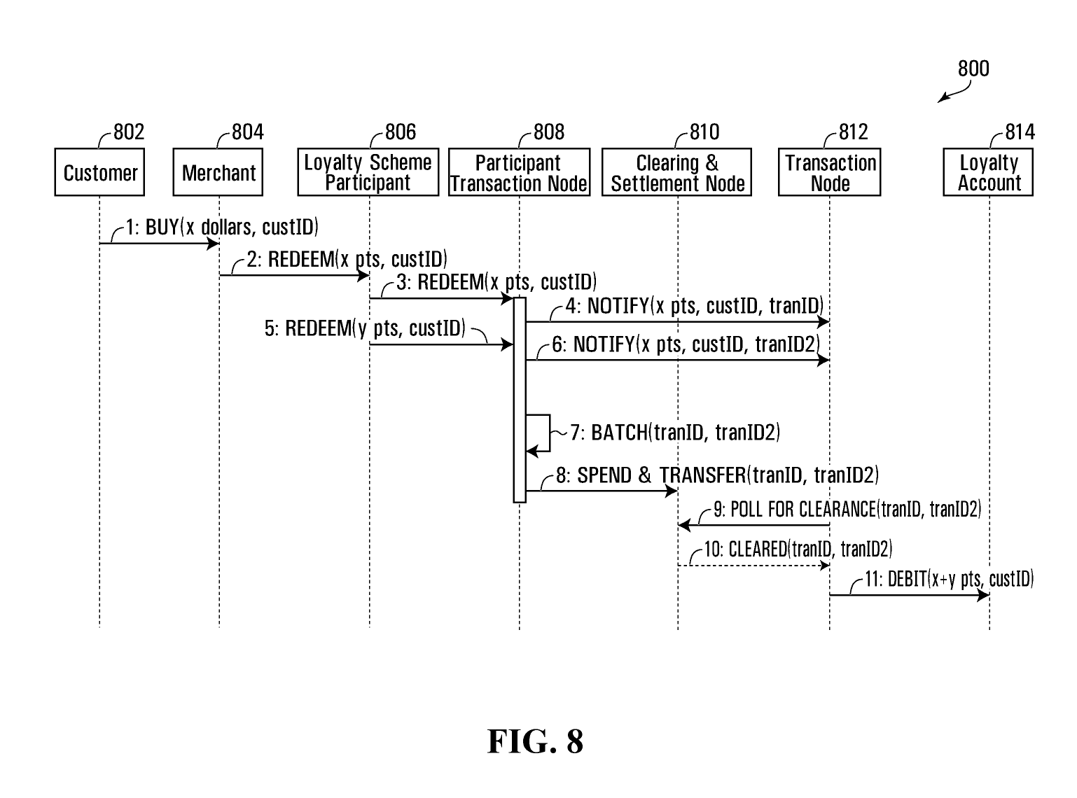

FIG. 8 is an example method 800 for a customer loyalty points transaction redemption-inter organizations, according to some embodiments. Customer redeems loyalty points via a merchant with a relationship with a Loyalty Scheme Participant. FI is notified of each transaction of points redeemed. The Loyalty Scheme partner batches a number of transactions and issues to the Decentralized Blockchain. FI will poll the Blockchain and will debit the points from the Loyalty Account when they have determined that the transactions have been issues to the Blockchain.

The transaction data can be recorded on the distributed ledger networks 404, 402. The customer 802 and the merchant 804 generate a buy transaction record that includes data such as item identifiers, transaction cost, customer identifier, transaction identifier, and so on. The data can be provided to loyalty system via merchant API, for example. The merchant 804 notifies the loyalty scheme participant 806 of a redeem transaction linked to the buy transaction. The redeem transaction record includes data such as an amount of loyalty points or x points and the customer identifier, along with transaction details. The redeem transaction record (e.g. amount of loyalty points or x points, the customer identifier, transaction identifier or tranID) can be provided from the loyalty scheme participant 806 to the participant transaction node 808. The participant transaction node 808 transmits a notify record (e.g. amount of loyalty points or x points, the customer identifier, transaction identifier or tranID) to the transaction node 812. Another redeem transaction record (e.g. amount of loyalty points or y points, the customer identifier, another transaction identifier or tranID2) can be provided from the loyalty scheme participant 806 to the participant transaction node 808. The participant transaction node 808 transmits another notify record (e.g. amount of loyalty points or y points, the customer identifier, transaction identifier or tranID2) to the transaction node 812.

A batch tool records all transaction identifiers (e.g. tranID, tranID2) to the private distributed ledger network 402, for example. The participant transaction node 808 issues and transfers the transactions (e.g. tranID, tranID2) to the clearing and settlement node 810. The public distributed ledger network 404 can manage the clearing and settlement node 810, for example. The transaction node 812 polls the clearing and settlement node 810 for clearance of the transactions (e.g. tranID, tranID2). The clearing and settlement node 810 transmits a cleared notification for the transactions (e.g. tranID, tranID2) to the transaction node 812.

A debit transaction record (e.g. amount of loyalty points, the customer identifier, transaction identifier) can be provided by the transaction node 812 to the customer's loyalty account 814.

### Loyalty Points Transaction Transfer-Intra

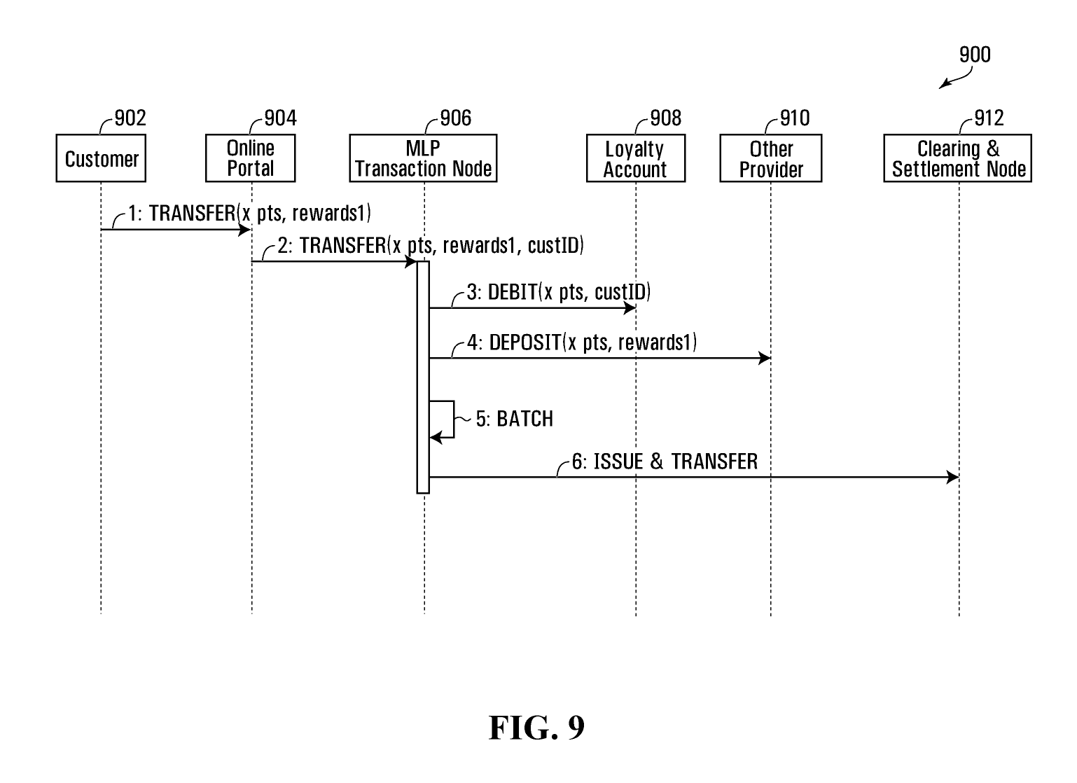

FIG. 9 is an example method for 900 a customer loyalty points transaction transfer-intra an organization, according to some embodiments. Customer transfers loyalty points via an Online Portal. Each transaction is debited into the customer's Loyalty Account and deposited into the account of the Other Provider when transferred with the batching and issuance to the Decentralized Blockchain at a later time.

The transaction data can be recorded on the distributed ledger networks 404, 402. The customer 902 generates a transfer transaction record at the online portal 904 that includes data such as customer identifier, amount of points, reward identifier or rewards1, and so on. The data can be provided to loyalty system via a customer API, for example. The online portal 904 notifies the FI MLP transaction node 906 of the transfer transaction record (e.g. customer identifier, amount of points, reward identifier). The FI MLP transaction node 906 generates a debit transaction record (e.g. amount of loyalty points or x points, the customer identifier) for the loyalty account 908. The FI MLP transaction node 906 generates a deposit transaction record (e.g. amount of loyalty points or x points, the customer identifier, rewards identifier or rewards1) for the other provider 910. A batch tool records all transaction identifiers (e.g. tranID, tranID2) to the private distributed ledger network 402, for example, by way of FI MLP transaction node 906. The FI MLP transaction node 906 issues and transfers the loyalty points using the clearing and settlement node 912.

### Loyalty Points Transaction Transfer-Inter

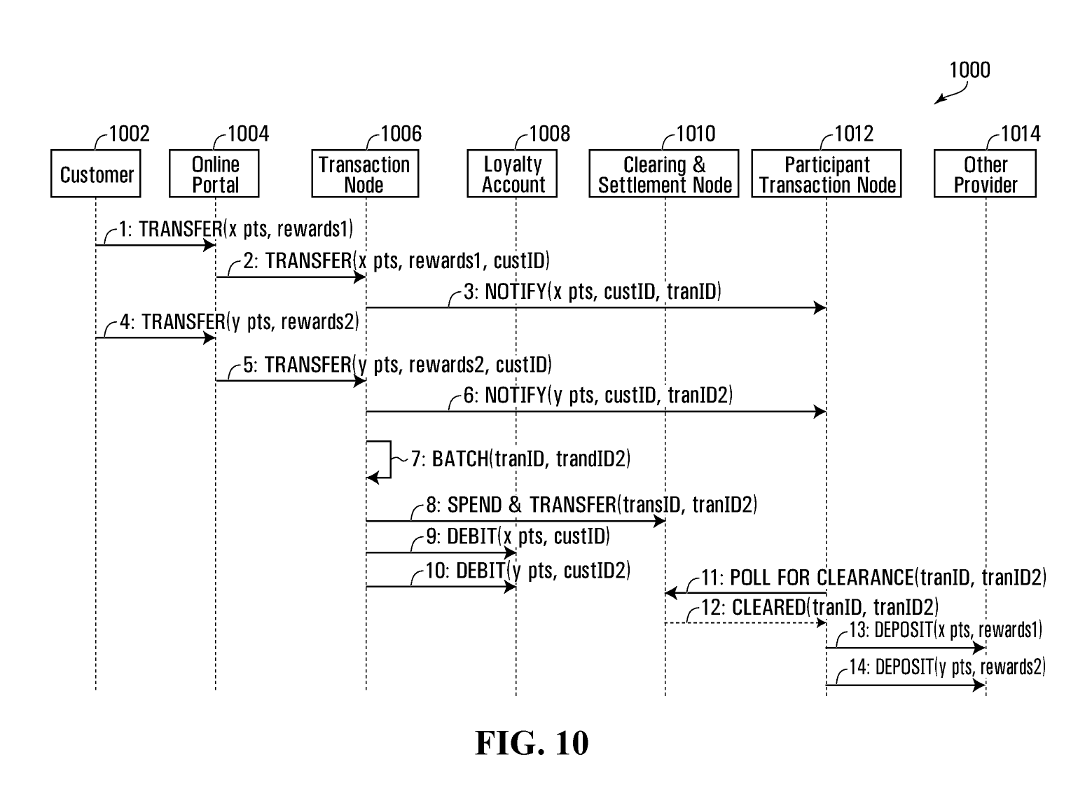

FIG. 10 is an example method 1000 for a customer loyalty points transaction transfer-inter organizations, according to some embodiments. Customer earns loyalty points via a merchant with a relationship with a Loyalty Scheme Participant. FI is notified of each transaction of points earned. The Loyalty Scheme partner batches a number of transactions and issues to the Decentralized Blockchain. FI will poll the Blockchain and will deposit the points to the Loyalty Account when they have determined that the transactions have been issues to the Blockchain.

The transaction data can be recorded on the distributed ledger networks 404, 402. The customer 1002 generates a transfer transaction record at the online portal 1004 that includes data such as customer identifier, amount of points or x points, reward identifier or rewards1, and so on. The data can be provided to loyalty system via a customer API, for example. The online portal 1004 notifies the transaction node 1006 of the transfer transaction record (e.g. customer identifier, amount of points, reward identifier). The transaction node 1006 generates a notification record of the transfer transaction record (e.g. customer identifier, amount of points, reward identifier) for the participant transaction node 1012.

The customer 1002 generates another transfer transaction record at the online portal 904 that includes data such as customer identifier, amount of points or y points, reward identifier or rewards2, and so on. The online portal 1004 notifies the transaction node 1006 of the other transfer transaction record (e.g. customer identifier, amount of points, reward identifier). The transaction node 1006 generates a notification record of the other transfer transaction record (e.g. customer identifier, amount of points, reward identifier) for the participant transaction node 1012.

A batch tool records all transaction identifiers (e.g. tranID, tranID2) to the private distributed ledger network 402, for example.

The transaction node 1006 generates a spend and transfer record for both transfer transaction records (e.g. tranID, tranID1). The transaction node 1006 generates a debit transaction record (e.g. customer identifier, amount of points, reward identifier) for each of the transfer transaction records for the clearing and settlement node 1010. The participant transaction node 1012 polls the clearing and settlement node 1010 for clearance of the transfer transaction records (tranID, tranID1). The clearing and settlement node 1010 generates a cleared notification for the transfer transaction records (tranID, tranID1). The participant transaction node 1012 generates deposit transaction records (x points, rewards1), (y points rewards2) for the transfer transaction records.

### Further Examples

In relation to the overhead into the system related to determining the interactions between the public/private distributed ledger network solutions, there may be further considerations around how to mint new points/credits (e.g., loyalty points), how to implement fraud prevention, how to minimize cost for authentication, authorization and audit across various APIs, how to reconciliation ledgers (e.g., with bulk clearing), synchronization after potential lost payment notifications, which ledger (e.g., the clearing and settlement ledger) will always be the truth, what happens in the event of missing transaction messages and there is be a discrepancy in the individual loyalty accounts, among others.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

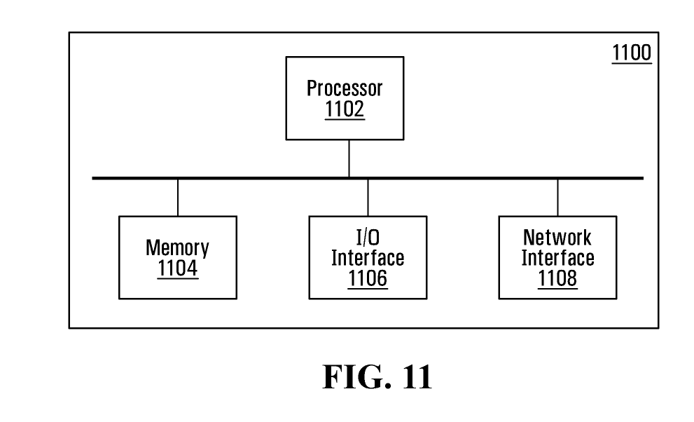

FIG. 11 illustrates a schematic of a computing device 1100 according to some embodiments.

As depicted, computing device 1100 may include a processor 1102, memory 1104, at least one I/O interface 1106, and at least one network interface 1106.

Processor 1102 may be, for example, a microprocessor or microcontroller, a digital signal processing (DSP) processor, an integrated circuit, a field programmable gate array (FPGA), a reconfigurable processor, a programmable read-only memory (PROM), or combinations thereof.

Memory 1104 may include a combination of computer memory that is located either internally or externally such as, for example, random-access memory (RAM), read-only memory (ROM), compact disc read-only memory (CDROM), electro-optical memory, magneto-optical memory, Ferroelectric RAM (FRAM), among others.

In some embodiments, memory 1104 may be accessible through network interface 1108. In some embodiments, memory 1104 may be delocalized across any number of servers accessible through use of network interface 1108.

Each I/O interface enables computing device 1100 to interconnect with one or more input devices, such as a keyboard, mouse, camera, touch screen and a microphone, or with one or more output devices such as a display screen and a speaker.

Each network interface 1108 enables computing device 1100 to communicate with other components, to exchange data with other components, to access and connect to network resources, to serve applications, and perform other computing applications by connecting to a network.

Embodiments described herein relate to providing a loyalty partner network using distributed ledger networks. The loyalty partner network allows onboarding of partners and customers, loyalty points management, secure inter-partner clearing while providing trust and security for end to end loyalty transactions.

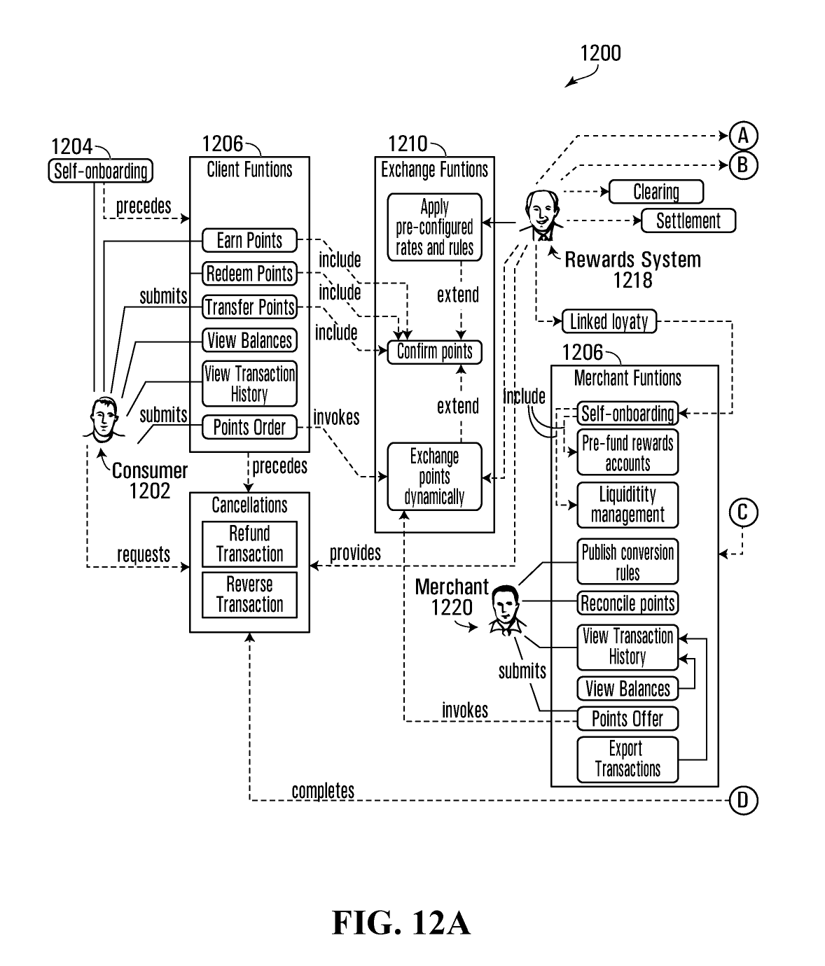

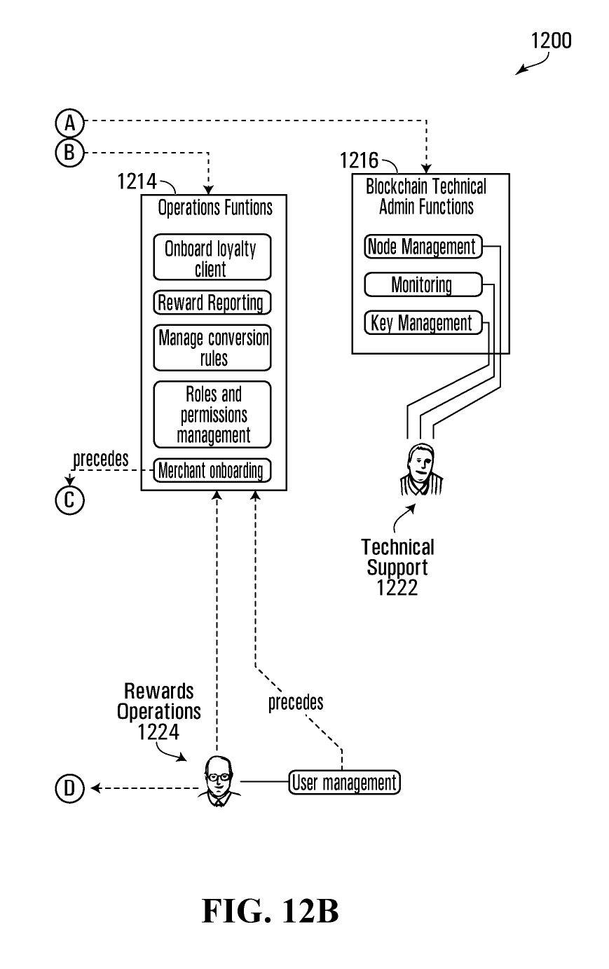

FIG. 12A and FIG. 12B shows a schematic diagram of a loyalty platform 1200. The loyalty platform 1200 can operate distributed trust network that provides security between loyalty partners. A distributed ledger network can support the loyalty platform 1200 to provide the secured distribution and trust across partners.

Merchant's request efficient onboarding processes, better points liquidity, simplified reconciliation processes, and real time transaction monitoring. The loyalty platform 1200 can provide solutions to these requests.

The loyalty platform 1200 can involve a private distributed ledger network, allowing loyalty partners such as merchants and other FIs to securely onboard, issue loyalty points, while facilitating clearing of the loyalty transactions. The loyalty platform 1200 can be referred to as a Wholesale Blockchain ledger

The loyalty platform 1200 can enable secure transactions processing and clearing between merchants and their correspondent FIs. The secure clearing is backed by Blockchain based consensus and cryptography scheme, as provided by the distributed ledger implementation.

Merchants can onboard their customers, partners and accounts data onto loyalty platform 1200, and can set up their credentials and identities to access different functions. Merchants can issue rewards points for their specific loyalty points currencies. Merchants can exchange their own points (which may be referred to as Merchant Rewards Currency) to their partner FI's currency (which may be referred to as FI rewards currency) using a pre-defined exchange rate. The loyalty platform 1200 can periodically receive and clear the retail points transactions after they were processed by a Retail Rewards ledger.

The loyalty platform 1200 configures processor using instructions stored on memory to provide a self-boarding unit 1204, client function unit 1206, cancellation unit 1208, exchange functions unit 1210, merchant functions unit 1212, operations functions unit 1214, administration unit, and so on.

Self-boarding unit 1204 generates a customer account with a customer identifier at the client function unit 1206. The client function unit 1206 enables loyalty account management for the following example functions: earn points, redeem points, transfer points, you balance, view transaction history, points order, and so on. The cancellation unit 1208 enables loyalty account management for the following examples: refund transaction, reverse transaction, and so on the exchange function unit 1210 enables loyalty account management for the following examples: convert points, exchange points dynamically, apply configured rules and rates, and so on. The merchant function unit 1212 enables loyalty account management for the following examples: onboarding, pre-fund rewards accounts, liquidity management, conversion rules, reconcile points, view transaction history, the balances, points offer, export transactions, and so on. The operations functions unit 1214 enables loyalty account management for the following examples: onboard loyalty client, rewards reporting, manage conversion rules, roles and permissions management, merchant onboarding, and so on the administration unit enables loyalty account management for the following examples: node management, monitoring, team management, and so on.

A customer 1202 submits a request to redeem points or transfer points to the client function unit 1206 for the loyalty points in its customer account. The request to redeem points triggers the client function unit 1206 to interact with the exchange function unit 1210 to convert points, in some embodiments. The conversion of points may call configured rates and rules or by dynamic exchange. A customer 1202 can also submit points order request which invokes the dynamic point exchange of the exchange function unit 1210. A customer 1202 can submit a request to earn points which may also trigger a call to the exchange function unit 1210 to convert points.

A customer 1202 can submit a request to cancel a transaction. The cancellation unit 1208 can interact with the client function unit 1206 to refund the transaction or reverse the transaction.

A merchant 1220 submit a points offer request to the merchant function unit 1212 which in turn triggers the exchange function unit 1210 to convert points in some embodiments. A merchant 1220 can onboard accounts using the merchant function unit 1212 which includes previous reward accounts and enables liquidity management for the points. A merchant 1220 can submit a request to view transaction history to the merchant function unit 1212 which can involve you in balances as well as export transactions.

A reward system participant 1218 can submit requests for clearing, settlement. A reward system participant 1218 can submit requests for a linked loyalty program which triggers an interaction with the merchant account function 1212 two onboard a customer account that can be linked to another reward account. A reward operations participant 1224 can facilitate user management with request to the operations functions unit 1214 four merchant onboarding, conversion management, reporting management, permissions and so on. A technical support participant 1222 and submit administrative requests to the administration unit 1216.

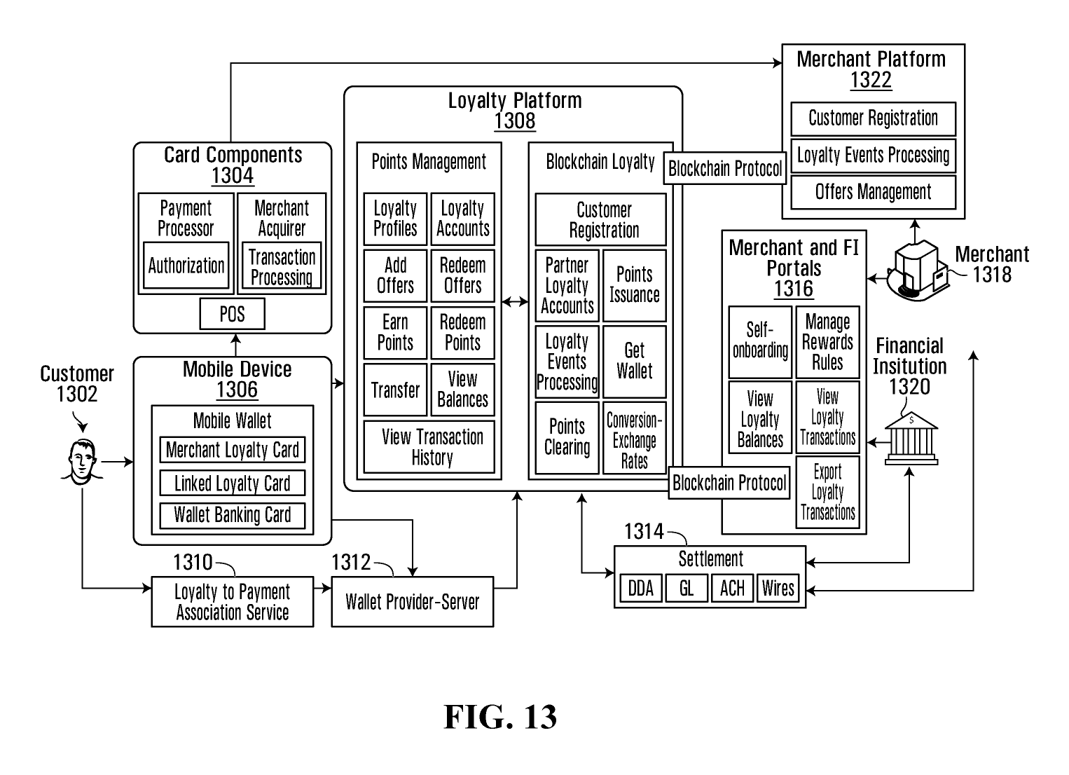

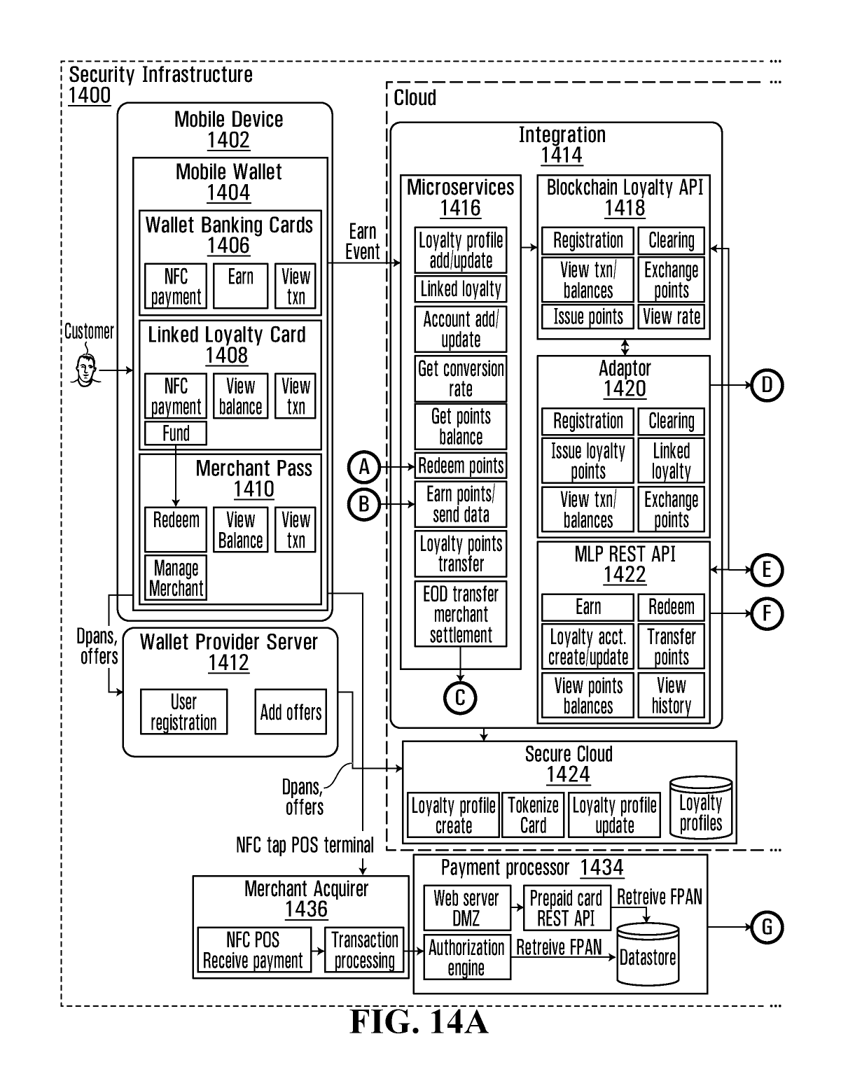

FIG. 13 shows an example architecture diagram 1300 of a loyalty platform 1308. A mobile device 1306 has an electronic wallet application (which can be referred to as a mobile wallet). The mobile device 1306 connects to the loyalty platform 1308 (by way of a network) to access loyalty program functionality. The mobile device 1306 connects to transaction card components 1304 to integrate with transaction processing for the customer 1302. The transaction card components 1304 connect to a merchant platform 1322 to integrate with transaction processing for the merchant 1318. The loyalty platform 1308 connects to a merchant and FI portal 1316 using a block chain or distributed ledger protocol. The loyalty platform 1308 connects to settlement system 1314 for FI 1320. The settlement system 1314 also connects to merchant platform 1322 and financial institutions for settlement functions.

A customer 1302 is linked to a mobile device 1306 having the electronic wallet application to manage different electronic accounts such as merchant loyalty card, linked loyalty card, wallet banking card, and so on. The electronic wallet application can be used to initiate or participate in transactions for the customer 1302. The electronic accounts can be used for payment for the transactions. The transactions can involve different electronic accounts. For example, the mobile device 1306 can interact with transaction card components 1304 for transaction processing. The transaction card components 1304 can include a payment processor (with authorization function), merchant acquirer (with transaction processing function) and a point of sale component. The transaction card components 1304 can interact with the merchant platform 1322 for transaction processing relating to the customer 1302 and the merchant 1318. The merchant platform 1322 can involve customer registration, loyalty events processing and offers management. The customer 1302 can also interact with a loyalty to payment association service 1310 and a wallet provider server 1312 to engage loyalty platform 1308.

The mobile device 1306 (with the electronic wallet application) can connect with loyalty platform 1308 to engage in the loyalty program. The loyalty platform 1308 involves points management and block chain loyalty infrastructure (with a block chain protocol). The points management provides different functions such as for example: loyalty profiles, loyalty accounts, add offers, redeem offers, earn points, redeem points, transfer, view balances, view transaction history, and so on. The block chain loyalty infrastructure provides different functions such as for example: customer registration, partner loyalty accounts, points issuance, loyalty events processing, get wallet, points clearing, conversion-exchange rates, and so on. The loyalty platform 1308 implements a block chain protocol to interact with the merchant and FI portal 1316 for the following example functions: onboarding, manage reward rules, view loyalty balances, view loyalty transactions, export loyalty transactions, and so on. The loyalty platform 1308 can connect with settlement unit 1314 for transaction settlement. The settlement unit 1314 can involve DDA, GL, ACH, Wres, and so on, for settlement of traditional payment transfer.

The following loyalty process provides an illustrative example. The mobile device 1306 can have a Linked Loyalty Card that is provisioned to the electronic wallet application. The consumer 1302 can earn merchant points (e.g. loyalty points) each time they complete a purchase transaction at the respective merchant store 1318. The points redemption can be performed using the Linked Loyalty Card via the electronic wallet application.

Customer loyalty transaction data is sent to Blockchain loyalty component of the loyalty platform 1308 for points management and to facilitate the net clearing between merchants 1318 and their financial institution (FI) 1320.

A Blockchain Loyalty component (of the loyalty platform 1308) can provide an exchange function to facilitate the conversion of points between different loyalty schemes or government backed currencies.

The partner (merchants and FIs) portal 1316 for merchants 1318 and FIs 1320 can provide the ability to self-onboard, view loyalty account balances, loyalty transactions and allow an interface with back-office systems to support reporting, reconciliation processes on their side.

End of day settlement between the merchant 1318 and its partner FI 1320 can happen via traditional payment rails (such as account transfers, ACH, wires) in some embodiments.

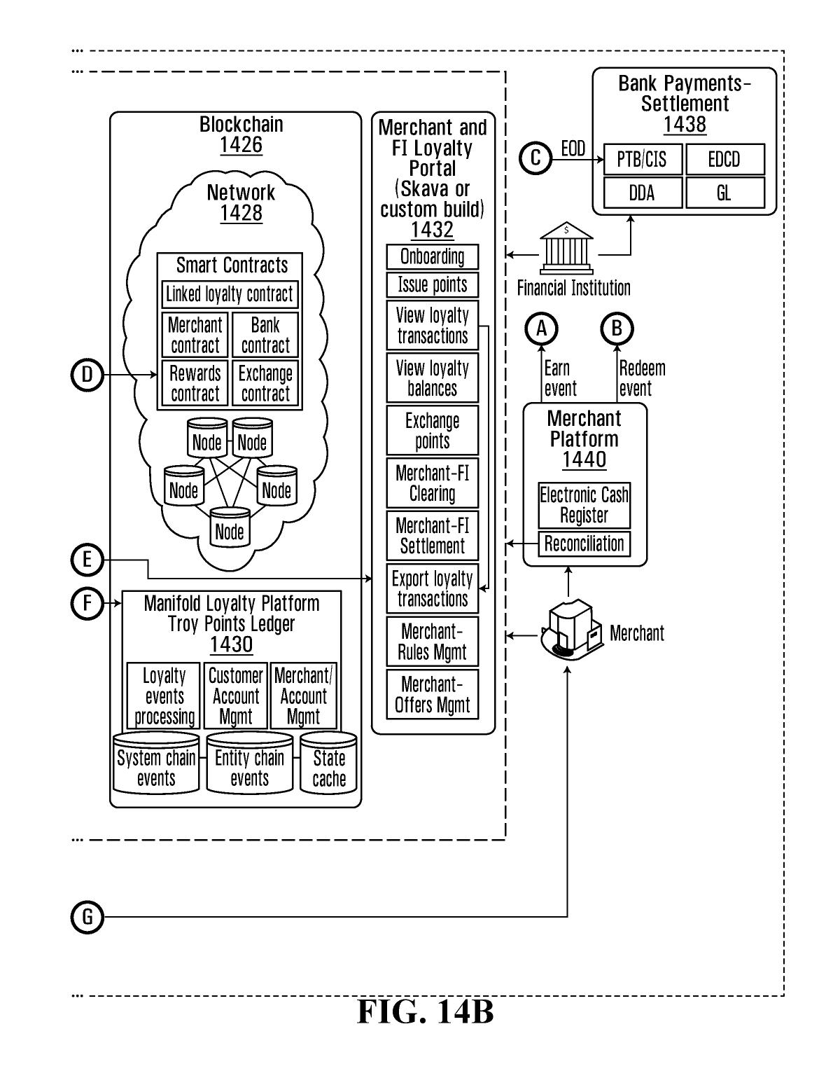

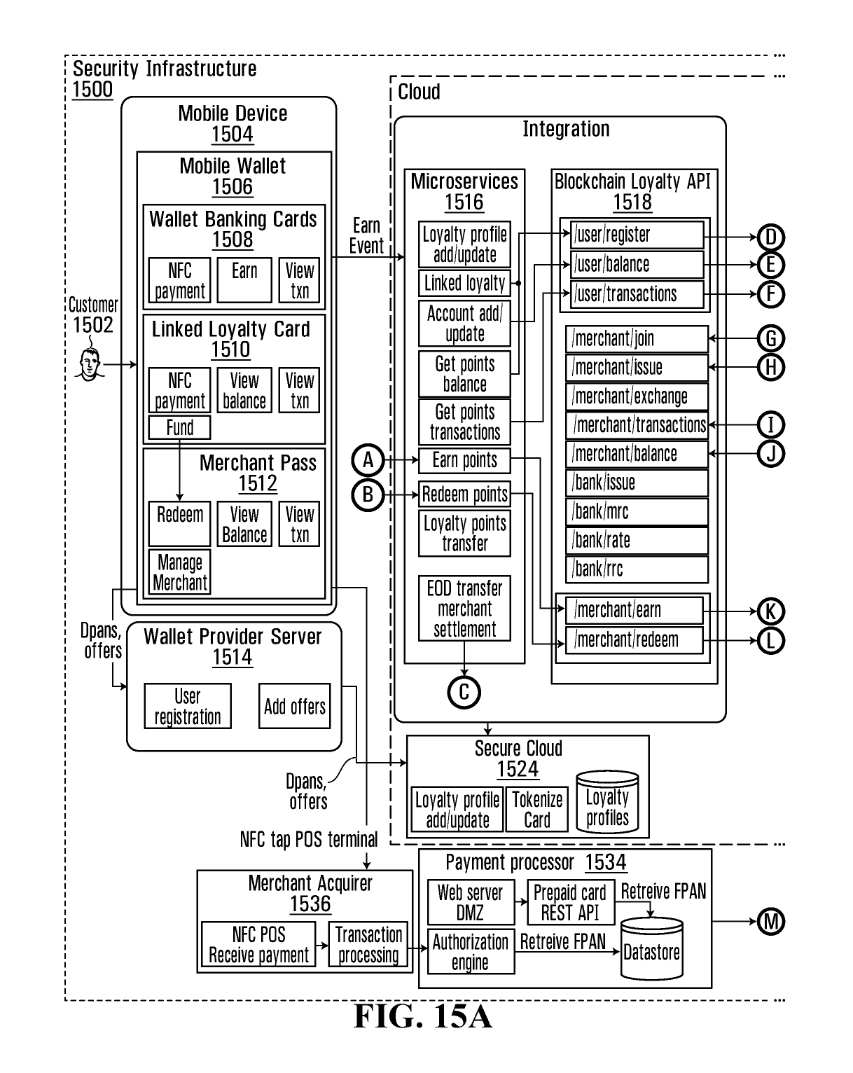

FIG. 14A and FIG. 14B shows an example system context diagram for loyalty platform 1400.

The loyalty platform includes a mobile device 1402 having on electronic wallet application 1404. The electronic wallet application 1404 can include wallet banking cards 1406, a linked loyalty card 1408, and a merchant pass 1410. The wallet banking cards 1406 can be used to process transactions with merchants. The wallet banking cards 1406 can include tokens representing customer accounts and can enable mobile payments. The linked loyalty card 1408 connects the mobile wallet 1404 to the loyalty platform 1400. The linked loyalty card 1408 can include an NFC payment token, a view balance function, view transactions function and a fund option. The fund option can interact with the merchant pass 1410 to redeem loyalty points for payment of transactions (or to fund the transaction).

The mobile device 1402 having the linked loyalty card 1408 can interact with the POS terminal by way of an NFC tap or other communication to pay for the transaction and trigger the loyalty process. A merchant acquirer 1436 can include an NFC POS component to receive payment and process the transaction. The merchant acquirer 1436 can interact with the payment processor 1434 to authorize and process the payment. The payment processor connects to a merchant platform 1440 to detect loyalty events in relation to the transaction. A loyalty event can be an earn event (a customer earns loyalty points) or redeem event (a customer redeems loyalty points for payment or portion of payment of a transaction). The electronic wallet application 1404 can connect with a wallet provider server 1412 for user registration and to add offers.

A loyalty event can trigger interactions between the linked loyalty card 1408 of the electronic wallet application 1404 and a cloud platform having integration services 1414, blockchain services 1426, partner loyalty portal 1432, and secure cloud services 1424.

The linked loyalty card 1408 helps manage a loyalty account for a customer. The loyalty account for client or merchant has an associated loyalty point balance, which can be 0 when created initially. The secure cloud components 1424 can be used for managing loyalty profiles and identities for users and merchants.

The linked loyalty card 1408 can be provisioned by the wallet provider server 1412 and stored in the electronic wallet application 1404. The wallet provider server 1412 can provide APIs which will support the Linked Loyalty card 1408 and the earn and redeem loyalty event functions.

The electronic wallet application 1404 is a user mobile application which integrates with existing wallets and has a provision Linked Loyalty Card.

The loyalty platform points ledger 1430 can be leveraged as the loyalty points bank (retail ledger) using a distributed ledger infrastructure. The Manifold loyalty platform points ledger 1430 can access the MLP API 1422 for integration purposes. The Merchant portal 1432 can connect to a merchant platform to process loyalty events. The Merchant portal 1432 can be integrated with current APIs for loyalty partners (onboarding, issuing points, exchange points).

Loyalty events (earn, redeem) can be linked to loyalty rules. The loyalty rules can be simple (e.g. each dollar of a currency spent will earn 1 merchant loyalty point) or complex (e.g. item A will earn 15 merchant points if purchased on a weekday evening) being provided by ledger 1430.

The merchant platform 1440 provides an ability to earn points with merchants while using other payment instruments (cash, debit, credit) that are not in the electronic wallet application 1404 and redeem points via the Linked Loyalty Card 1408.

The secure cloud components 1424 provides Loyalty profiles management and card tokenization functions.

The client side API 1422 can enable loyalty profile creation. It creates a loyalty profile, linked to an FI client profile in case the end user is an FI client. The loyalty profile is created with a status of active, and it contains information about loyalty type (gold, silver, bronze), eligibility criteria to be categorized in a certain loyalty type (such as number of loyalty transactions to become a gold loyalty customer). Each loyalty profile can have an unique loyalty profile ID.

The Secure Cloud component 1424 maintains and stores the loyalty profile. The Secure Cloud component 1424 interacts with the client side API 1422 and updates the loyalty profile information, such as eligibility criteria, loyalty type, and permissions. The Secure Cloud component 1424 retrieves the loyalty profile information based on a loyalty profile ID, the list of loyalty accounts, the loyalty profile status, loyalty type, eligibility criteria, or permissions.

The micro service API 1416 creates a loyalty account to be managed by Secure Cloud component 1424, and the loyalty account is attached to a client loyalty profile. Each account can have an unique ID and it will be linked to a LOB account (deposit, credit etc.). The account can be created with a status of ‘active’.

The loyalty account will be maintained in the Rewards Blockchain component 1426.

The micro service API 1416 updates the loyalty account preferences, name, etc. The micro service API 1416 updates the loyalty account with a status of ‘inactive’ and in this state the account might no longer be available for loyalty transactions. The micro service API 1416 retrieves the loyalty account preferences and retrieves the total points balance for an active loyalty account ID

The micro service API 1416 can get a transaction history and retrieves a list of loyalty transactions for an active loyalty account ID. This list can contain the loyalty transactions (such as earn) which occurred as part of user's activity (purchase, open account etc.). The micro service API 1416 can support pagination, returning a configurable number of transactions per page, in case the transaction history list is larger than 1000 rows.

The micro service API 1416 can support Loyalty operations for different types of loyalty events (e.g. earn, redeem, transfer, exchange).

The micro service API 1416 can support the “earn” points function based on a user's activity such as purchase, opening account, submitting a survey etc. Each loyalty activity or event will have corresponding and configurable earning rules which will apply to calculate the number of earned points. The earning operation will result in a credit transaction to the respective loyalty account. When the earning is happening as part of a purchase, then a banking product (deposit account, credit card) can be used to complete the purchase transaction.

The micro service API 1416 can support the “redeem” points function to redeem a certain amount of loyalty points as selected by the end user, when he performs a purchase or when he requests cash back for his points. The redeeming operation can result in a debit operation to the respective loyalty account. The loyalty account balance is verified before completing the redemption.

The micro service API 1416 can support the “transfer” points function to perform a points transfer between two different loyalty accounts. The transfer operation can perform an atomic operation containing a debit to the source loyalty account and a credit to the target account. The transfer will not perform a currency conversion, and it will use the same currency for both operations.

The micro service API 1416 can support the “exchange” points function to converts points from one currency scheme to a difference currency scheme (e.g. merchant points, FI Rewards points, government backed currencies CAD, USD), based on pre-configured conversion rates. The client side API 1422 can support a storage function and the conversion rates can be stored on Blockchain, to allow further extensibility of a points exchange marketplace between parties.

The Blockchain Loyalty API Merchant API 1418 supports the merchant specific functions, such as registration, view transactions, view balances.

The Blockchain Adaptor 1420 is responsible to broker the requests to the Private Ledger 1428. The Blockchain Adaptor 1420 provides APIs to process loyalty events (earn, redeem), create blockchain accounts, issue loyalty points, and so on.

The Private Ledger 1428 has Loyalty smart contracts that provide the smart contracts logic for creating blockchain accounts, issue points, commit transactions, and so on. Smart contracts are designed as such that they can support change management being backwards compatible, concurrency and multi-threading.

MLP API 1422 which supports the loyalty functions overlaid over Manifold Blockchain ledger, such as create account, transfer points, get transactions. The MLP API 1422 can also accept cleared transactions from Ethereum network to mark them as cleared.

The points ledger 1430 can provide points management functions to end users and merchants, such as create account, earn, redeem, view transactions, and so on.

The Merchant and FI loyalty Portal 1432 supports the merchant functions, providing a user interface which integrates with Blockchain Loyalty APIs.

Settlement component 1438 supports the ability to send an aggregated transaction at the end of business day, to facilitate the exchange of funds between merchant and its associated FI.

The cloud infrastructure can support components, such as Blockchain Loyalty API, blockchain adaptor 1420, MLP, private network 1428.

The cloud infrastructure can support security and identity management for Loyalty partners and Permissions and access control for Loyalty partners.

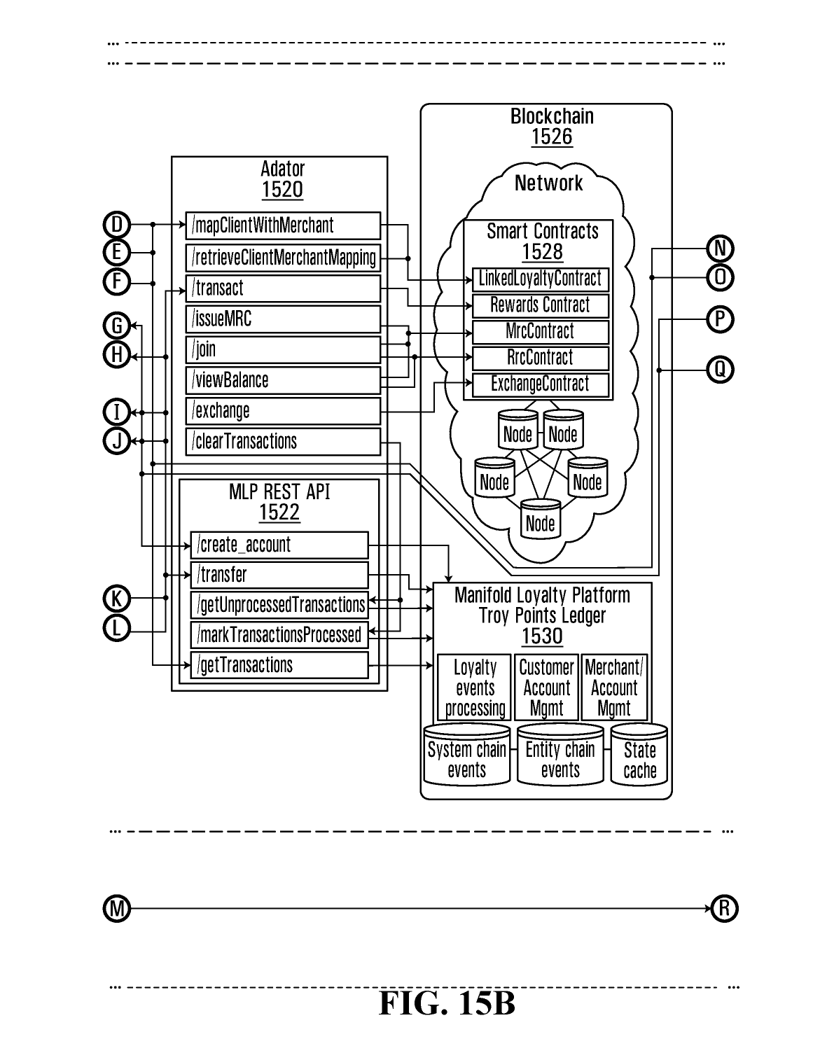

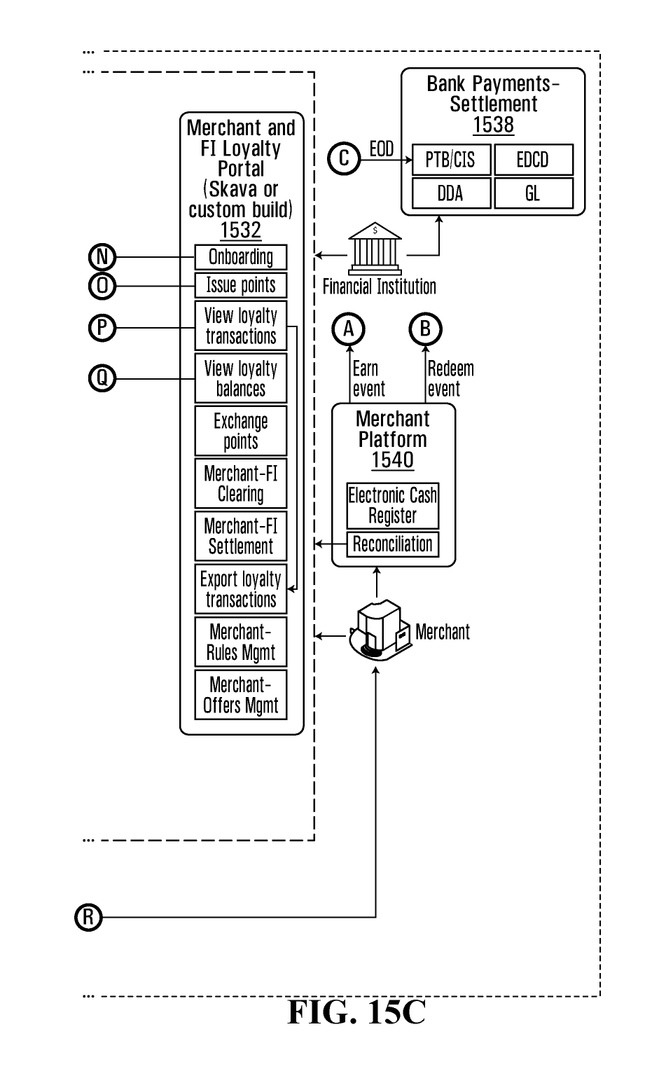

FIG. 15A, FIG. 15B and FIG. 15C illustrates an example architecture diagram of a loyalty platform. FIG. 15A, FIG. 15B and FIG. 15C illustrate components similar to the architecture diagram of FIG. 14A and FIG. 14B with some variations, such as for micro services 1516, blockchain loyalty API 1518, blockchain adaptor 1520, and MLP REST API 1522.

The mobile device 1504 has an electronic wallet application or mobile wallet 1506 which includes payment cards 1508, merchant passes 1512, and a linked loyalty card 1510. The customer 1502 uses its mobile wallet 1506 with the linked loyalty card 1510 to engage with loyalty platform for different loyalty events. A wallet provider server 1514 can connect to the mobile wallet 1506 for user registration and offer configuration.

The loyalty platform includes micro services 1516, block chain loyalty API 1518, block chain adapter 1520, the block chain 1526, MLP REST API 1522, secure cloud 1524, points ledger 1530, smart contracts 1528, merchant and FI loyalty portal 1532. The mobile wallet 1506 interacts with merchant acquirer 1536 for electronic payment processing which in turn connects to payment processor 1534 and merchant platform 1540. Payments can also be processed using payments and settlement 1538.

Micro services 1516 include different components to send requests and retrieve data from the loyalty platform and its distributed ledger or block chain. Micro services 1516 include a component to add or update a loyalty profile for the customer 1502 and a linked loyalty component to integrate with the linked loyalty card 1510 provisioned on the mobile wallet 1506. Micro services 1516 includes a component to add or update loyalty account micro services 1516 include components to get loyalty points balance, get point transaction, earn points, redeem points, transfer points, and merchant settlement. Micro services 1516 interact with the linked loyalty card 1510 to trigger different components and exchange data.

The block chain loyalty API 1518 includes different components to interface between micro services 1516 and the block chain adapter 1520 and the block chain 1526. The block chain loyalty API 1518 includes the following example components or code functions: user/register, user/balance, user/transactions, merchant/join, merchant/issue, merchant/exchange, merchant/transactions, merchant/balance, bank/issue, bank/rate, bank/rcc, merchant/earn, merchant/redeem.

The block chain adapter 1520 includes different components to interface between the block chain loyalty API 1518 and the block chain 1526, along with other parts of the loyalty platform. The block chain adapter 1520 includes the following example components: /mapclientwithmerchant/, /retrieveclientmerchantmapping/, /transact/, /issueMRC/, /join/, /viewBalance, /exchange, /cleartransactions, and so on.

The MLP REST API 1522 includes the following example components: /create_account, /transfer, /getUnprocessedTransactions, /markTransactionsProcessed, /getTransactions, and so on.

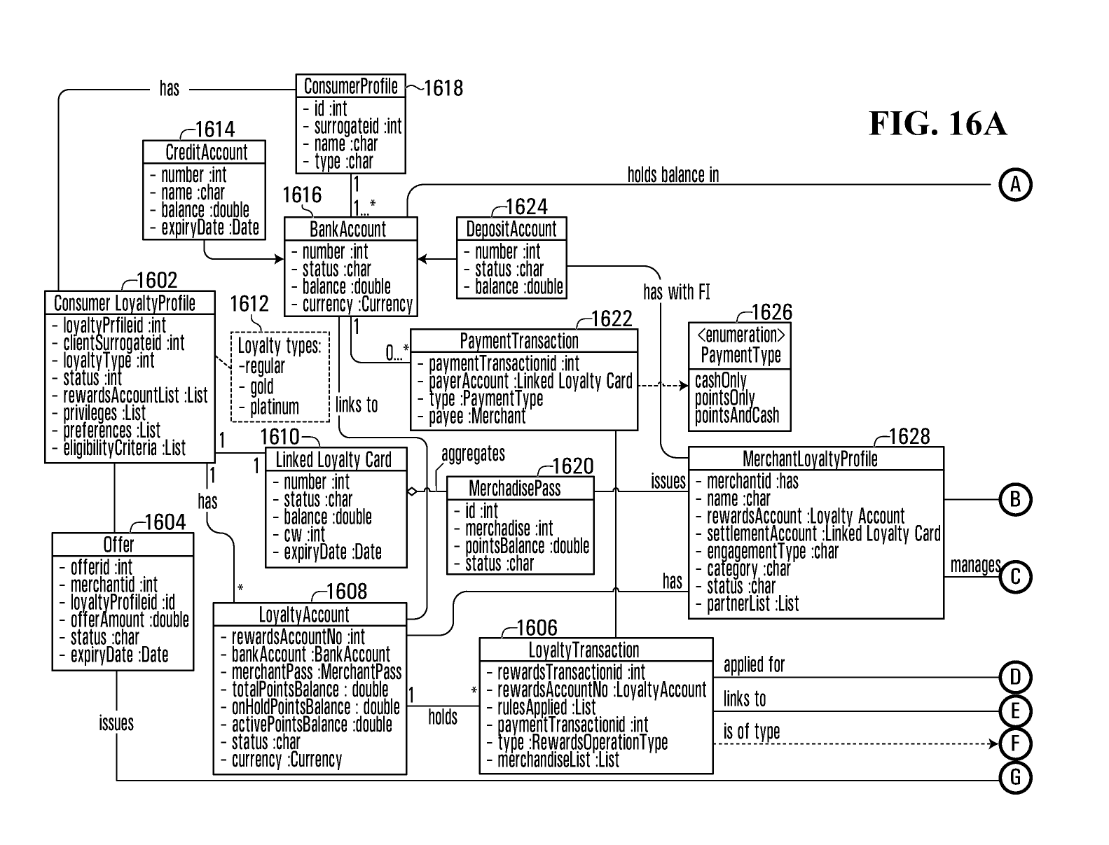

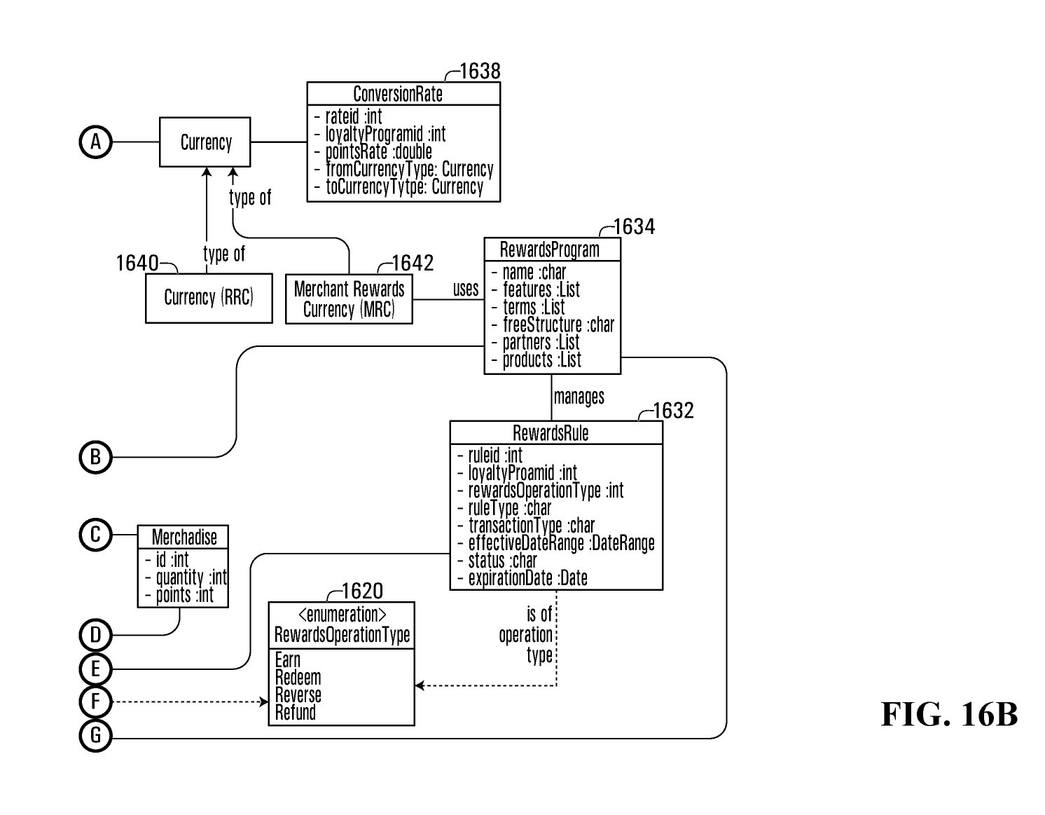

FIG. 16A and FIG. 16B illustrates a data model 1600 diagram for the loyalty platform. A consumer loyalty profile 1602 includes different data objects such as for example: loyalty profile ID, client surrogate ID loyalty type, status, rewards account list, privileges, preferences, eligibility criteria, and so on. The consumer loyalty profile 1602 is linked to a linked loyalty card 1610. The consumer loyalty profile 1602 as a loyalty account 1608 which hold a loyalty transaction 1606. The consumer loyalty profile 1602 has a consumer profile 1618 which is linked to a bank account 1616. Loyalty types 1612 include regular, gold, platinum, and so on.

The linked loyalty card 1610 has different data objects such as for example: number, status, balance, CW, expiry date, identifier, and so on. A merchant pass 1620 aggregates linked loyalty card 1610 the merchant pass 1620 links to a loyalty account 1608. A merchant loyalty profile 1628 issues the merchant passed 1620. The merchant pass 1620 has different data objects such as for example: identifier, merchant ID, points balance, status, and so on. The merchant passes 1620 are aggregated under a linked loyalty card 1610 allowing the user to pay with its usual banking cards and or redeem points. The merchant loyalty profile 1628 enables a merchant to maintain a loyalty account on the loyalty platform (MLP) and on the distributed ledger or block chain for loyalty settlement. The merchant loyalty profile 1628 has different data objects such as for example: merchant ID, name, rewards account or loyalty account, settlement account for the linked loyalty card, engagement type, category, status, partner list, and so on.

The merchant loyalty profile 1628 has a loyalty account 1608. The loyalty account 1608 has different data objects such as for example: rewards account number, bank account, merchant pass, total points balance, on whole points balance, active points balance, status, currency, and so on. The loyalty account 1608 holds a loyalty transaction 1606. A loyalty transaction has different data objects such as for example: rewards transaction ID, rewards account number, rules applied, payment transaction ID, type or rewards operation type, merchant list, and so on. A loyalty transaction 1606 is of a rewards operation type 1620 (type of loyalty event). The rewards operation type 1620 has different data objects such as for example: earn, redeem, reverse, refund and so on. As noted, the rewards rules 1632 manages rewards programs 1634. The rewards rules 1632 is of an operation type linked to the rewards operation type 1620. The rewards rules 1632 has different data objects such as for example: rule ID, loyalty program ID, rewards operation type, rule type, transaction type, effective date range, status, expiration date, and so on. The rewards program 1634 has different data objects such as for example: name, features, terms, fee structure, partners, products, and so on. The reward rules 1632 can relate to different transaction types such as all transactions, recurring payments, bill payments, and so on.

The merchant loyalty profile 1628 manages merchandise seen 30. Merchandise 1630 has different data objects such as for example: ID, quantity, loyalty points, and so on.

The consumer loyalty profile 1602 is linked to an offer 1604. A rewards program 1634 issues an offer 1604 and is managed by rewards rules 1632. The offers 1604 have different data objects such as for example: offer ID, merchant ID, loyalty profile ID, offer amount, status, expiry date, and so on.

The rewards program 1634 uses merchant rewards currency 1642 which is a type of currency 1636. FI rewards currency 1640 is another type of currency 1636. A conversion rate 1638 converts currency 1636. Conversion rate 1638 has different data objects such as for example: rate ID, loyalty program ID, points rate, from currency type, to currency type, and so on. Example currencies 1636 include US dollars, Canadian dollars, FI rewards currency 1640, merchant reward currency 1642, and so on.

The bank account 1616 can be a credit account 1614 or deposit account 1624. A bank account 1616 has different data objects such as for example: number, status, balance, currency, and so on. A credit account 1614 has different data objects such as for example: number, name, balance, expiry date. A deposit account 1624 has different data objects such as for example number, status, balance, and so on. A consumer profile 1618 is linked to a bank account 1616. A consumer profile 1618 has different data objects such as for example ID, circuit ID, name, type, and so on. A consumer can either be an FI client or non-FI client. A bank account 1616 is linked to payment transactions 1622. Payment transaction 1622 have different data objects such as for example: payment transaction ID, payer account or linked loyalty card, type or payment type, payee or merchant, and so on. A payment transaction 60 is of payment type a payment type 1626 which can have different data objects such as cash only, points only, points and cash.

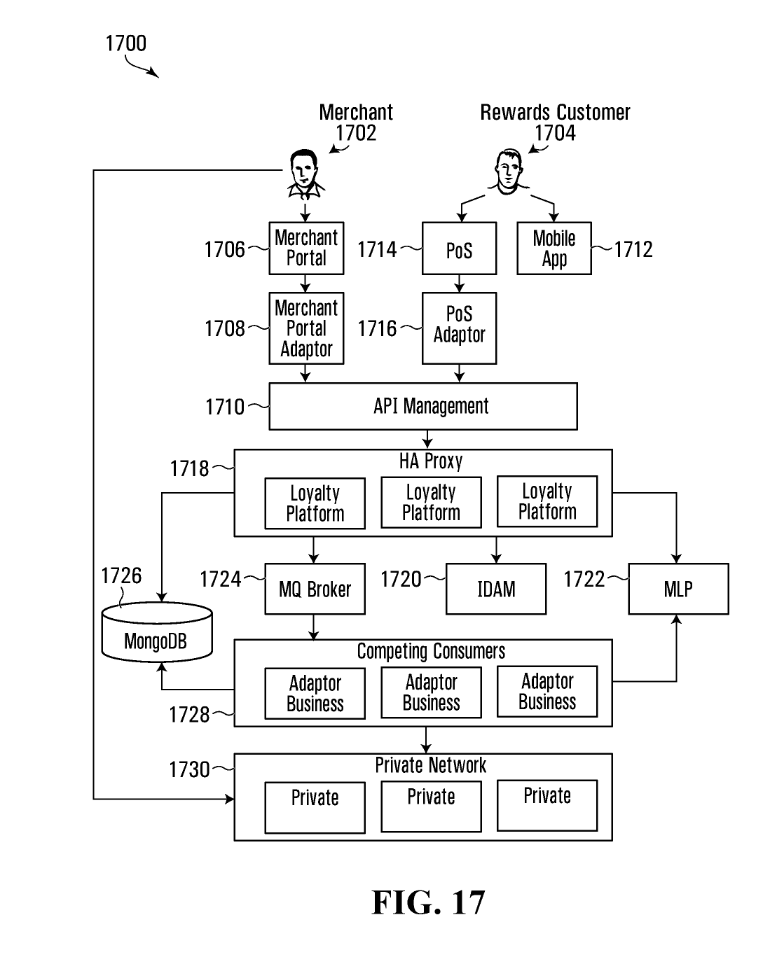

FIG. 17 illustrates a security application 1700 architecture for loyalty platform. The security application provides authentication, authorization, and session management across multiple application components. The security application 1700 includes a rewards customer 1704 that has a mobile application 1712 and can interact with the POS 1714 which in turn connects to a POS adapter 1716 to connect with API management 1710. A merchant 1702 interacts with the merchant portal 1706 which in turn interacts with the merchant portal adapter 1708 to connect to API management 1710. The API management 1710 connects to an HA proxy 1718 with loyalty platform instances thereon. The HA proxy 1718 connects to IDAM 1720 and an MQ broker 1724. The MQ broker 1724 connects consumers 1728 with adapter business which in turn connect to a Mongo DB 1726 and MLP 1722. The merchant 1702 connects to the private block chain network 1730 for the loyalty program.

The security application 1700 enables identity management that can involve user provisioning and de-provisioning. Partners can register in the loyalty portal using their profile (email, name, partner type etc.). They can select unique identifier, password for further authentication into the portal. The partner unique identifier can be linked to its respective accounts keys. The security application 1700 can automatically de-provision accounts for closed merchant accounts and their agents. The security application 1700 temporarily lock accounts with repeated failed login attempts (e.g. more than 3) and provide support to affected users. security application 1700 can use pluggable realms (secure data access objects) to connect to external directories (for merchants which have their own user base). It can provide the ability to authenticate a user against one or more realms and return one unified view of their identity.

The security application 1700 enables identity management that can involve a password policy. The security application 1700 can enforce a strong password policy (e.g. eight characters minimum, with mixed case and at least one number or special character). The security application 1700 can store all passwords in non-reversible one-way cryptographic hash. The security application 1700 can encrypt credentials in transit: Credentials such as usernames, passwords and session identifiers should always be encrypted in transit. Passwords might never be sent in the same communication with a username/userID. The security application 1700 can offer a secure password reset feature, including verification of identity, email or text notification and a one-time-use password link that expires after 24 hours.

The security application 1700 can enable authentication. The security application 1700 can enable partner authentication using his credentials (user id, password) for accessing: portal layer; its private node. The security application 1700 can propagate authenticated partner (merchant, bank) credentials throughout all application layers, within the same authenticated session. The security application 1700 can support session management to support federated session across multiple components: portal, API, Blockchain. The security application 1700 can enable identity propagation between application components and layers. The security application 1700 can provide automatic session expiration. The security application 1700 can provide ability for users to logout from their current session. The security application 1700 can provide session data clustering. The security application 1700 can enable single sign-on between merchant portal and their existing/internal loyalty platform. The security application 1700 can enable multi factor authentication to add a second layer of security to user sign-ins and transactions.

The security application 1700 can enable authorization. The security application 1700 can enable Role-Based Access Control (RBAC) to be used to assign permissions to users, groups, and applications at a certain scope. Roles can be separated in following groups: administrator; partner—merchant; partner—financial institution; and auditor.

Authorization checks can verify the user has appropriate role to perform the requested action, and also the correct scope. Scope authorization checks should reference merchant-agent, merchant-financial institution relationships, and so on. The security application 1700 can provide authorization controls for administrators to manage loyalty partners and their employees (agents). The security application 1700 can enable authorization logic to be highly configurable and modified without requiring code changes. The security application 1700 can enable multi-tenancy support for all components, by partitioning the resource space into (hierarchical) logical security domains.

The security application 1700 can enable encryption. This can involve key management to safeguard the encryption keys and secrets by leveraging a Key Vault. This can use a Key Vault to audit keys and policy usage. This can use disk encryption with the Key Vault to help control and manage disk encryption keys and secrets in the key vault subscription, while ensuring that all data in the virtual machine disks are encrypted at rest in storage. The security application 1700 can enable data protection in transit (e.g. by the use SSL/TLS or VPN) or at rest (e.g. file or SQL based encryption). The security application 1700 can encrypt VMs data volumes and boot volume in order to protect data at rest in storage account.

The security application 1700 can enable audit logging for operations on Non-public Data. The creation, retrieval, modification or deletion of non-public data can be carefully tracked.

The security application 1700 can track authentication events. This can include: failed login attempts, password reset requests, lockouts, user creation/enrollment/deletion and the last successful login to be logged. This can also log all successful and failed authentication attempts, including date, time, IP address, and username. Any authorization check which fails can be logged. Authorization failures can throw an exception, generate a log event, and display a generic error message to the user. Information to include in log entries can be date, time, username, IP address, and a description of the event being logged.

The following describes example features of the API specification for reward client and merchant specific functions, such as registration earn, redeem and viewing loyalty activity. The API can relate to the APIs described in relation to FIGS. 3, 4, 14, 15 and 17 for example.

The reward or loyalty program APIs can facilitate execution of the following capabilities: manage client registration with specific merchant; earn points with merchant; redeem points with merchant; view loyalty points balances; view loyalty transactions; and so on.

The following acronyms may be used herein: Digitized primary account number (DPAN), and Manifold Loyalty Platform (MLP)

The reward or loyalty program APIs can be used to integrate the mobile client application functions (e.g. electronic wallet application, linked loyalty card) with the backend components.

Client side Rewards API specifications

An example API is Register Client with Merchant Loyalty. This API can be responsible to map the client banking cards from a mobile wallet or electronic wallet application to a selected merchant loyalty program (e.g. that can be accessed using the linked loyalty card). The API stores in block chain ledger the mapping between each clients' DPAN, Merchant ID with a client's Loyalty ID. This mapping can have a status as “active”, or “inactive”. When the mapping is initially created, the status can be marked as “active”.

This API may assume that the client is already enrolled in the merchant loyalty program and he has a loyalty card with the merchant. In some embodiments, the API can first check to see if the client is enrolled and if not initiate the enrollment process and send a notification to the client.

This API may assume that electronic banking cards and electronic loyalty cards are already stored in the mobile wallet or electronic wallet application. In some embodiments, the API can first check to see and if not initiate an installment process and send a notification to the client. This API may assume that the client selected the merchant that they are looking to register for the linked loyalty program.

This API will call BlockchainService (or more generally Service) which can be a software wrapper for a smart contract implementation of a Linked Loyalty contract for the loyalty program. This API may expose REST, with JSON payload. This API can also include an authentication component.

The following table provides example Request/Response Parameters for the Client with Merchant Loyalty API:

| ID | Element | Type | Description |
|---|---|---|---|
| 1 | DPAN | String | The digitized primary account number |
| | | (16) | of client's banking card (credit, or |
| | | | debit) |
| 2 | Merchant | String | The unique identifier for the merchant |
| | Identifier | (25) | |
| 3 | Merchant Card | String | The identifier representing the merchant |
| | Identifier | (16) | loyalty card owned by the client |
| | Status code | String (3) | The status code for this request: |
| | | | SUC = Success |
| | | | ERR = Error |
| | Error reason | String | If the status code is ERR = Error, then |
| | code | | the Error reason code needs to contain |
| | | | the error code for failure, such as: |
| | | | General error |

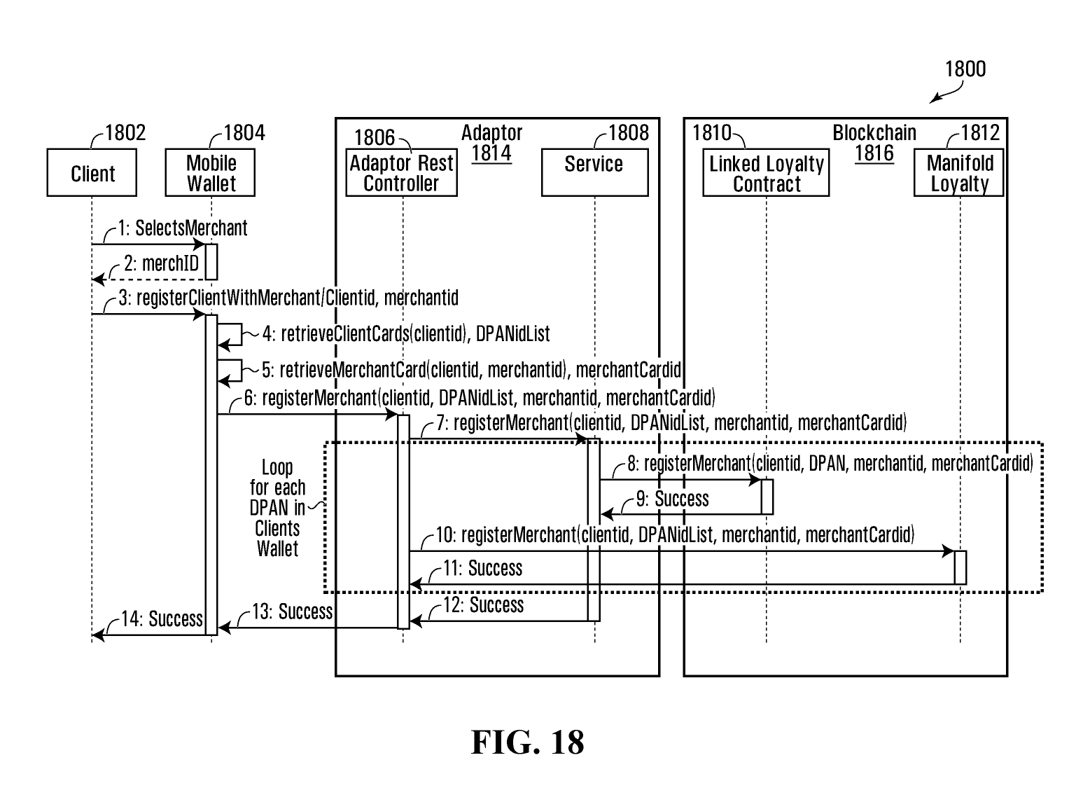

FIG. 18 provides a process 1800 for a loyalty program and relates to the Client with Merchant Loyalty.

Client 1802 selects a merchant for a loyalty program (e.g. loyalty event) using the electronic wallet application 1804 (e.g. mobile wallet). The electronic wallet application 1804 returns a merchant ID. The client 1802 registers its client ID with the merchant loyalty program identified by the merchant ID at the electronic wallet application 1804 (which may be an API function registerClientWthMerchant (clientid, merchantid)).

The electronic wallet application 1804 retrieves the client card linked to the client ID (which may be an API function retrieveClientCards (clientID)). The electronic wallet application 1804 retrieves the merchant card ID for the loyalty program using the client ID and the merchant ID (which may be an API function (clientid, merchantid):merchatCardID). The electronic wallet application 1804 registers the Merchant with the Adaptor 1814 and in particular with the AdaptorRestController 1806 (which may be an API function registerMerchant(clientid, DPANidlist, merchantid, merchantCardid)). The AdaptorRestController 1806 in turn registers the Merchant with the block chain Service 1808 (which may be an API function registerMerchant(clientid, DPANidlist, merchantid, merchantCardid)).

The block chain Service 1808 registers the Merchant with the Block chain 1816 and in particular the linked loyalty contract 1810 (which may be an API function registerMerchant(clientid, DPANidlist, merchantid, merchantCardid)). The linked loyalty contract 1810 can send a successful registration notification message to the block chain Service 1808. The AdaptorRestController 1806 sends a request to create a client loyalty merchant account to the Block chain 1816 and in particular to the Manifold Loyalty 1812 (which may be an API function createClientLoyaltyMerchantAccount(clientid, DPAN, merchantid, merchantCardid). The Manifold Loyalty 1812 can send a successful account creation notification message to the AdaptorRestController 1806. There may be multiple DPAN IDs in the client's electronic wallet application 1804 (DPANidlist) and these steps may be completed for each DPAN ID in the client's electronic wallet application 1804. After this is completed for the DPAN ID in the client's electronic wallet application 1804, the block chain Service 1808 can send a successful registration notification message to the AdaptorRestController 1806, which in turn can send a successful registration notification message to the electronic wallet application 1804, which in turn can provide notification to the client 1802.

An example API is Retrieve Client Merchant Loyalty. This API can be responsible to retrieve the merchant loyalty identifier and the client's points balance for the specific merchant.

The Client might be already enrolled in the merchant loyalty program and have a loyalty card with the merchant. The banking cards and loyalty cards can be stored in the electronic wallet application. The client might be previously registered with the merchant with Linked loyalty card or program. The Client loyalty balance for each merchant can be maintained on the merchant platform, which can be the system of record for this data element. Client loyalty balance for each merchant can be maintained on the Blockchain retail ledger (MLP).

A synchronization process can be used between the Blockchain ledger and merchant's platform, as the client can spent/earn points outside of this platform (online or he can use cash). The earn/redeem can be unified at the channel and payment instrument level.

Blockchain ledger can store merchant points separately for each client. The alternative is to exchange all points into FI Reward Currency and convert them to merchant points when necessary. This might lose the price spread between merchant points, requiring merchant validation.

This API can invoke the following services through AdaptorRestController, composing their responses: BlockchainService which is a wrapper for smart contract implementation of Linked Loyalty contract to retrieve the LoyaltyID from the Blockchain; current Points bank (Manifold) to retrieve the points balance for the client and merchant

This API can expose REST, with JSON payload and can involve authentication.

The Retrieve Client Merchant Loyalty API can involve the following example Request Parameters:

| ID | Element | Type | Description |
|---|---|---|---|
| 1 | DPAN | String | The digitized primary account number of |
| | | (16) | client's banking card (credit, or debit) |
| 2 | Merchant | String | The unique identifier for the merchant |
| | Identifier | (25) | |

The Retrieve Client Merchant Loyalty API can involve the following example Response Parameters:

| ID | Element | Type | Description |
|---|---|---|---|
| 1 | Merchant Card | String | The identifier representing the loyalty |
| | Identifier | (16) | card owned by the client |
| 2 | Status code | String (3) | The status code for this request: |
| | | | SUC = Success |
| | | | ERR = Error |
| 3 | Error reason | String | If the status code is ERR = Error, then |
| | code | | the Error reason code needs to contain |
| | | | the error code for failure, such as: |
| | | | General error |

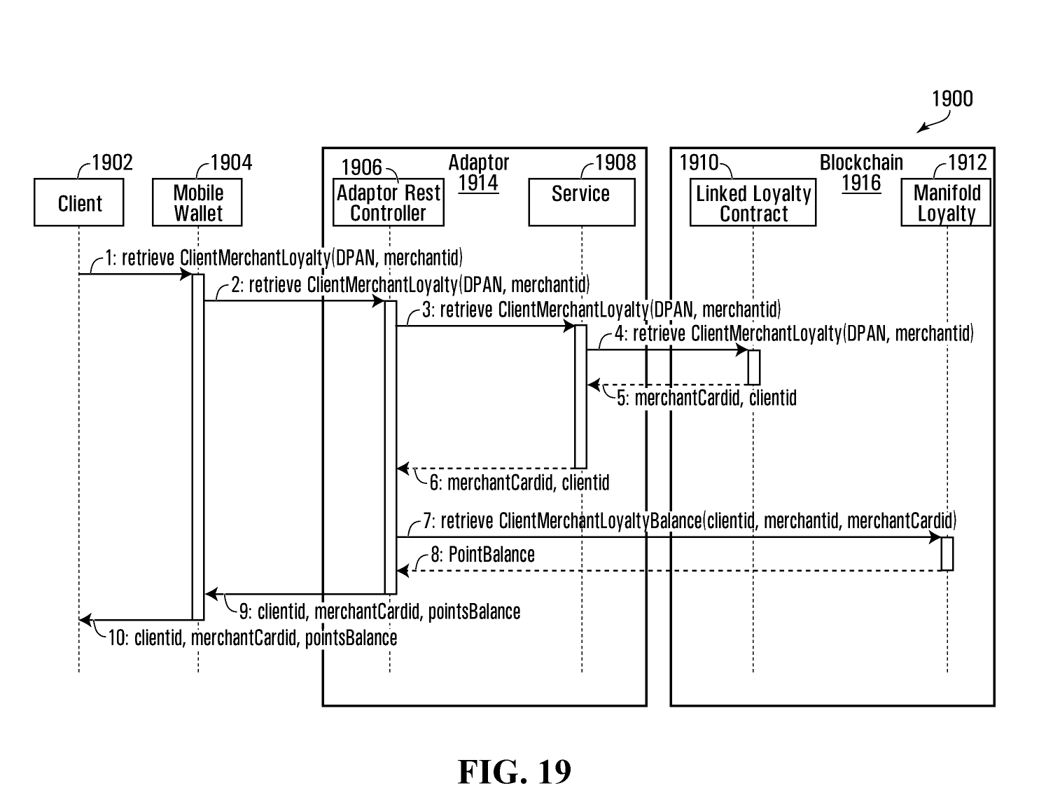

FIG. 19 is a process 1900 for a loyalty program and can relate to the Retrieve Client Merchant Loyalty API.

A client 1902 can send a retrieve client merchant loyalty request (e.g. loyalty event) to the electronic wallet application 1904 (which may be an API function retrieveClientMerchantLoyalty (DPAN, merchantID). The electronic wallet application 1904 can send a retrieve client merchant loyalty request to the Adaptor 1914 and in particular to the AdaptorRestController 1906 (which may be an API function retrieveClientMerchantLoyalty (DPAN, merchantID). The AdaptorRestController 1906 can send a retrieve client merchant loyalty request to the block chain service 1908 which can in turn send a request to the blockchain 1916 and in particular the LinkedLoyalty contract 1910 (which may be an API function retrieveClientMerchantLoyalty (DPAN, merchantID). The LinkedLoyalty contract 1910 can send the merchant card ID and the client ID to the block chain service 1908 (merchantCardID, clientID) which can in turn send it to the AdaptorRestController 1906. The AdaptorRestController 1906 can send a retrieve client merchant loyalty balance request to the Manifold Loyalty 1912 (which may be an API function retrieveClientMerchantLoyalty (clientID, merchantID, merchantCardID)). The Manifold Loyalty 1912 can send the points balance (pointsBalance) to the AdaptorRestController 1906. The AdaptorRestController 1906 can send the clientID, merchantCardID, and the pointsBalance to the electronic wallet application 1904 and in turn the client 1902.

An example API is Remove Client Merchant Loyalty. This API can be responsible to remove the mapping between merchant loyalty identifier and the client's loyalty, by marking its status as “inactive”. The Client can be enrolled in the merchant loyalty program and he has a loyalty card with the merchant. The banking cards and loyalty cards can be stored in the electronic wallet application. The Client can be registered the merchant with Linked loyalty. Client loyalty balance for each merchant is maintained on the merchant platform, which is the system of record for this data element.

The Remove Client Merchant Loyalty API can call BlockchainService which is a wrapper for smart contract implementation of Linked Loyalty contract. The API can expose REST, with JSON payload and can have authentication.

The Remove Client Merchant Loyalty can have the following example Request Parameters:

| ID | Element | Type | Description |
|---|---|---|---|
| 1 | DPAN | String | The digitized primary account number of |
| | | (16) | client's banking card (credit, or debit) |
| 2 | Merchant | String | The unique identifier for the merchant |
| | Identifier | (25) | |
| 3 | Merchant Card | String | The identifier representing the loyalty card |
| | Identifier | (16) | owned by the client |

The Remove Client Merchant Loyalty can have the following example Response Parameters:

| ID | Element | Type | Description |
|---|---|---|---|
| 2 | Status code | String (3) | The status code for this request: |
| | | | SUC = Success |
| | | | ERR = Error |
| 3 | Error reason | String | If the status code is ERR = Error, then |
| | code | | the Error reason code needs to contain the |
| | | | error code for failure, such as: |
| | | | General error |
| | | | TBD |

An example API is Earn Merchant Loyalty Points. This API can responsible for earning customer points after he completed a purchase in a merchant store (POS, Online etc.). The Client can already be enrolled in the merchant loyalty program and he has a loyalty card with the merchant. The banking cards and loyalty cards are already stored in the electronic wallet application. The Client can be registered the merchant with Linked loyalty program. The earning rules for each merchant can be maintained on MLP.

Earning rule management can be implemented for merchants or there can be integration with merchant earning rules.

The Earn Merchant Loyalty Points API can invoke the following services through AdaptorRestController, composing their responses: current Points bank (Manifold) to store the earned points for the client and merchant. The API can expose REST, with JSON payload and can involve authentication.

The Earn Merchant Loyalty Points can involve the following example Request Parameters:

| ID | Element | Type | Description |
|---|---|---|---|
| 1 | Client Identifier | String | The client identifier. This element can be the linked |
| | | (16) | loyalty card identifier. |
| 2 | Merchant Card | String | The identifier representing the merchant loyalty card |
| | Identifier | (16) | owned by the client |
| 3 | Merchant | String | The unique identifier for the merchant |
| | Identifier | (25) | |
| 4 | Transaction | | Data structure containing the transaction details: |
| | details | | Amount = the total purchase amount |
| | | | Merchandise list = list of merchandises |
| | | | purchased by client containing: |
| | | | Merchandise name, SKU |
| | | | Quantity |
| | | | Price |

The Earn Merchant Loyalty Points can involve the following example Response Parameters:

| ID | Element | Type | Description |
|---|---|---|---|
| 1 | Points balance | Decimal | The total points balance after earning |
| | | | new points for this purchase |
| 2 | Status code | String (3) | The status code for this request: |
| | | | SUC = Success |
| | | | ERR = Error |
| 3 | Error reason | String | If the status code is ERR = Error, then |
| | code | | the Error reason code needs to contain |
| | | | the error code for failure, such as: |
| | | | General error |
| | | | TBD |

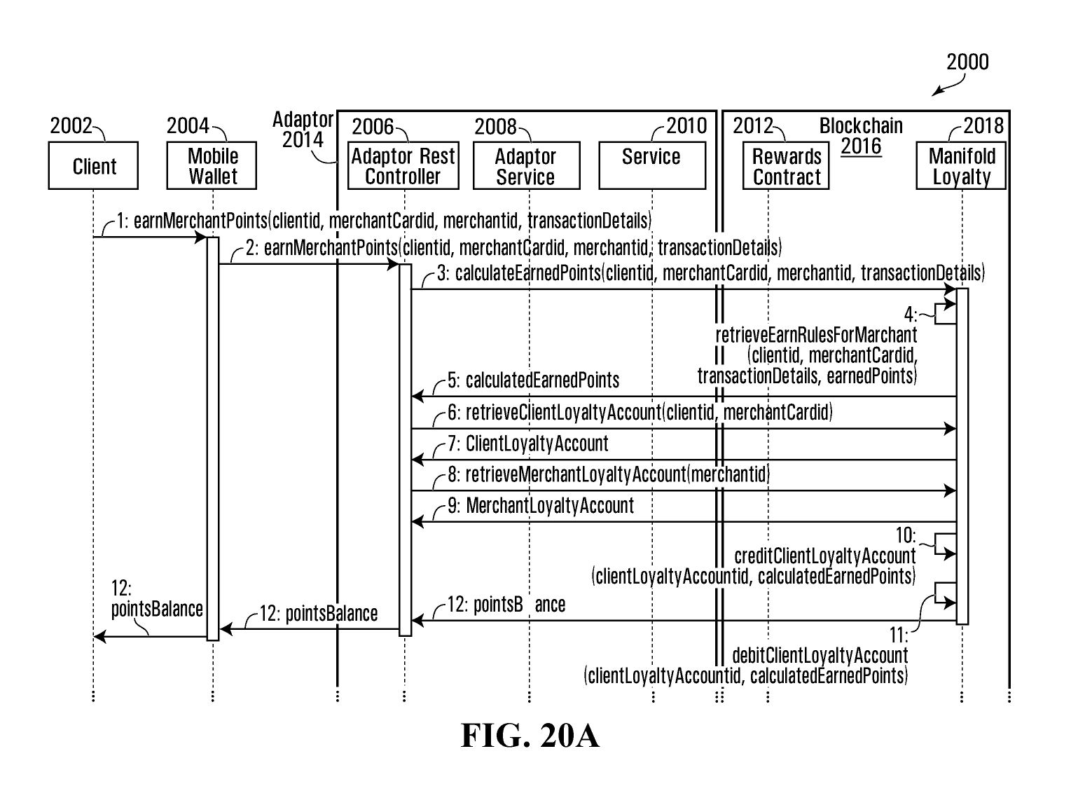

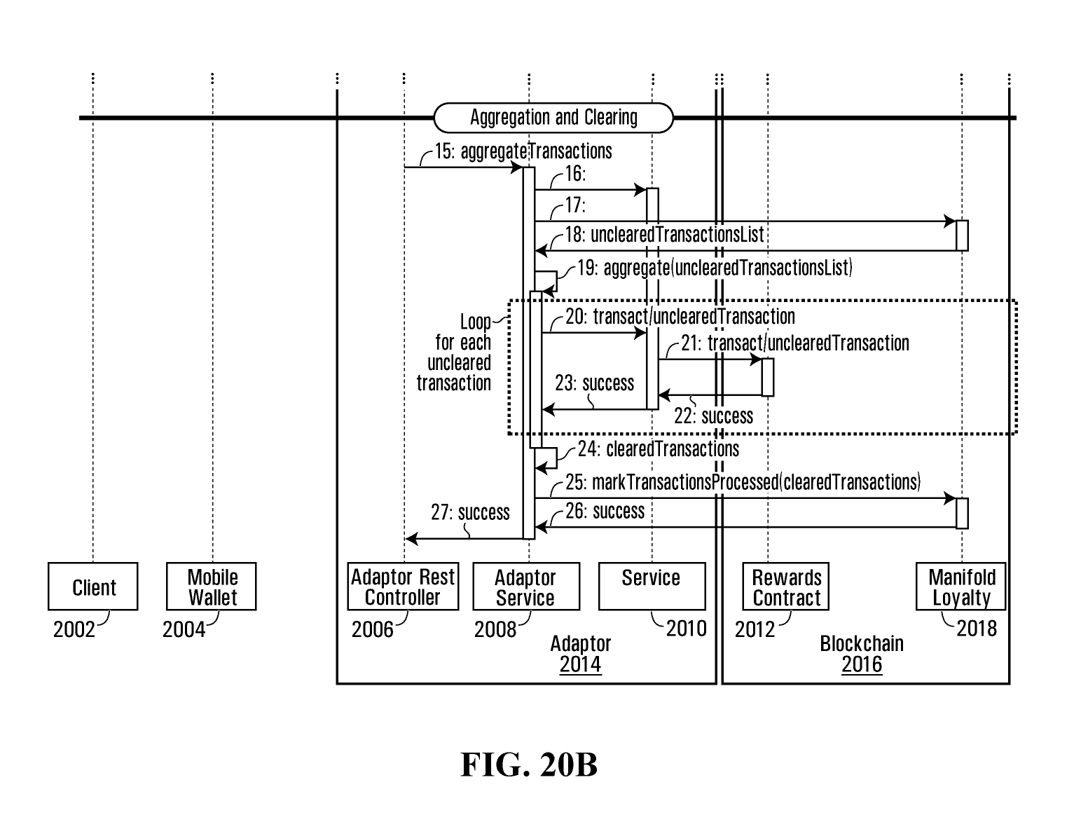

FIG. 20A and FIG. 20B illustrates an example process 2000 for the loyalty program and relates to the Earn Merchant Loyalty Points.

The client 2002 sends a request to earn loyalty points (e.g. loyalty event) to the electronic wallet application 2004 which can include data for clientID, merchantCardID, merchantID, and transaction details (which may be an API function earnMerchantPoints (clientID, merchantCardID, merchantID, transactiondetails)). The electronic wallet application 2004 sends a request to earn loyalty points to the Adaptor 2014 and in particular to the AdaptorRestController 2006 (which may be an API function earnMerchantPoints (clientID, merchantCardID, merchantID, transactiondetails)). The AdaptorRestController 2006 sends a calculate earned points request to the Blockchain 2016 and in particular the Manifold Loyalty 2018 (which may be an API function calculateEarnedPoints (clientID, merchantCardID, merchantID, transactiondetails)). The Manifold Loyalty 2018 retrieves rules for merchant (which may be an API function retrieveEarnRulesforMerchant (clientID, merchantID, transactiondetails, earnedPoints)). The Manifold Loyalty 2018 sends the calculated earned points to the AdaptorRestController 2006. The AdaptorRestController 2006 sends a request to retrieve the client loyalty account to the Manifold Loyalty 2018 (which may be an API function (retrieveClientLoyaltyAccount (clientid, merchantcardid)). The Manifold Loyalty 2018 sends the AdaptorRestController 2006 the ClientLoyaltyAccountID. The AdaptorRestController 2006 sends a request to retrieve the merchant loyalty account to the Manifold Loyalty 2018 (which may be an API function (retrieveMerchantLoyaltyAccount (merchantcardid)). The Manifold Loyalty 2018 sends the AdaptorRestController 2006 the MerchantLoyaltyAccountID. The Manifold Loyalty 2018 credits the client account (which may be an API function creditClientLoyaltyAccount (clientLoyaltyAccountID, calculateEarnedPoints). The Manifold Loyalty 2018 debits the merchant account (which may be an API function debitMerchantLoyaltyAccount (merchantLoyaltyAccountID, calculateEarnedPoints). The Manifold Loyalty 2018 sends the point balance to the AdaptorRestController 2006. The AdaptorRestController 2006 sends the point balance to the electronic wallet application 2004 which in turn sends the point balance to the client 2002.

The process 2000 also involves aggregation and clearing. The AdaptorRestController 2006 sends an aggregateTransaction request to the AdaptorService 2008. The AdaptorService 2008 sends a runTransactionAggregationandClear( ) request to the Block chain service 2010. The AdaptorService 2008 sends a fetchUnprocessedTransaction request to the Manifold Loyalty 2018 which returns an unclearedTransactionList. The AdaptorService 2008 aggregates the unclearedTransactionList to a blockchain. For each uncleared transaction, the AdaptorService 2008 sends a request to transact the uncleared transaction (which may be an API function transact(unclearedTransaction) to the Block chain service 2010 which in turn sends the request to transact the uncleared transaction (which may be an API function transact(unclearedTransaction) to the reward contract 2012. The reward contract 2012 sends a success notification to the Block chain service 2010 which is relayed to the AdaptorService 2008. The AdaptorService 2008 runs a cleared transaction request. The AdaptorService 2008 sends a mark transaction processed request to the Manifold Loyalty 2018 (which may be an API function markTransactionProcessed (clearedTransactions)). The Manifold Loyalty 2018 sends a success notification to the AdaptorService 2008 which is relayed to the AdaptorRestController 2006.

An example API is Redeem Merchant Loyalty Points. The Redeem Merchant Loyalty Points API can be responsible for redeeming customer points when he is completing a purchase in a merchant store (POS, Online etc.). The Client can be enrolled in the merchant loyalty program and he has a loyalty card with the merchant. The banking cards and loyalty cards are stored in the electronic wallet application. The Client can be registered the merchant with Linked loyalty program. The redemption rules for each merchant can be maintained on MLP.

Redemption rule management can be implemented for merchants or there can be integration with merchant redemption rules.

The Redeem Merchant Loyalty Points API can invoke the following services through AdaptorRestController, composing their responses: current Points bank (Manifold) to store the redeemed points for the client and merchant. The API can expose REST, with JSON payload and can have authentication.

The Redeem Merchant Loyalty Points API can involve the following example Request Parameters:

| ID | Element | Type | Description |
|---|---|---|---|
| 1 | Client Identifier | String | The client identifier. This element can be the linked |
| | | (16) | loyalty card identifier. |
| 2 | Merchant Card | String | The identifier representing the merchant loyalty card |
| | Identifier | (16) | owned by the client |
| 3 | Merchant | String | The unique identifier for the merchant |
| | Identifier | (25) | |
| 4 | Transaction | | Data structure containing the transaction details: |
| | details | | Amount = the total purchase amount |
| | | | Merchandise list = list of merchandises |
| | | | purchased by client containing: |
| | | | Merchandise name, SKU |
| | | | Quantity |
| | | | Price |
| 5 | Points | Decimal | The amount of points to be redeemed by the client |
| | Redeem | | |

The Redeem Merchant Loyalty Points API can involve the following example Response Parameters:

| ID | Element | Type | Description |
|---|---|---|---|
| 1 | Points balance | Decimal | The total points balance after redeeming |
| | | | points for this purchase |
| 2 | Status code | String (3) | The status code for this request: |
| | | | SUC = Success |
| | | | ERR = Error |
| 3 | Error reason | String | If the status code is ERR = Error, |
| | code | | then the Error reason code needs to |
| | | | contain the error code for |
| | | | failure, such as: |
| | | | General error |
| | | | TBD |

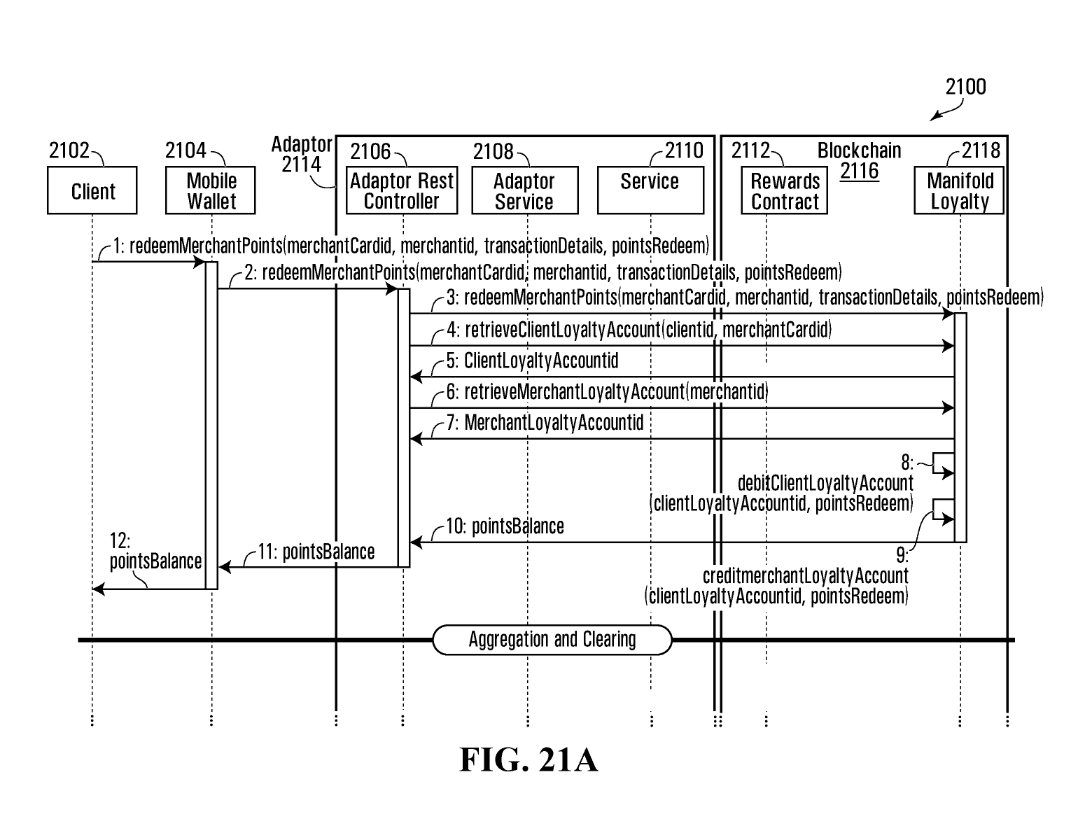

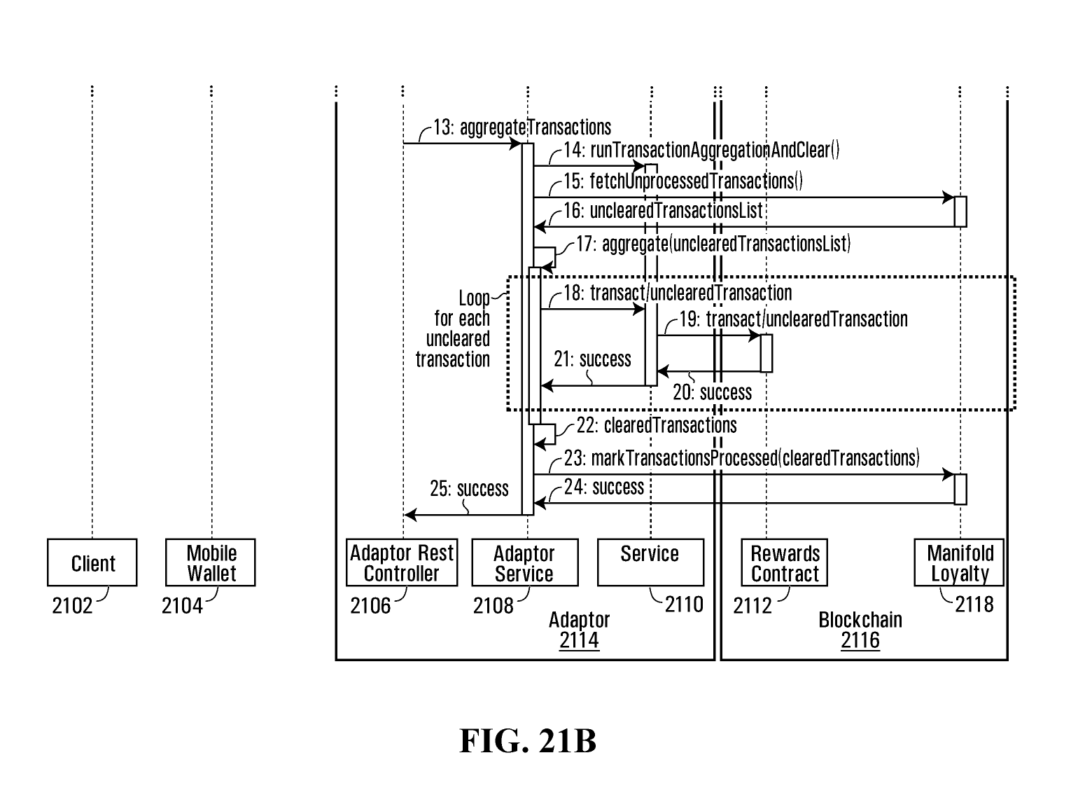

FIG. 21A and FIG. 21B illustrates an example process 2100 for a loyalty program that relates to Redeem Merchant Loyalty Points API.

The client 2102 sends a redeem points request to the to the electronic wallet application 2104 (which may be an API function redeemMerchantPoints (merchantCardID, merchantID, transactiondetails, pointsRedeem)). The electronic wallet application 2004 sends a request to redeem points to the Adaptor 2114 and in particular to the AdaptorRestController 2106 (which may be an API function redeemMerchantPoints (merchantCardID, merchantID, transactiondetails, pointsRedeem)). The AdaptorRestController 2106 sends a request to redeem points to the Manifold Loyalty 2118 (which may be an API function redeemMerchantPoints (merchantCardID, merchantID, transactiondetails, pointsRedeem)). The AdaptorRestController 2106 sends a request to retrieve client loyalty account to the Manifold Loyalty 2118 (which may be an API function retrieveClientLoyaltyAccount (clientID, merchantCardid). The Manifold Loyalty 2118 sends the client loyalty account ID in response. The AdaptorRestController 2106 sends a request to retrieve merchant loyalty account to the Manifold Loyalty 2118 (which may be an API function retrieveMerchantLoyaltyAccount (merchantid). The Manifold Loyalty 2118 sends the merchant loyalty account ID in response. The Manifold Loyalty 2118 debits the client account (which may be an API function debitClientLoyaltyAccount (clientLoyaltyAccountID, PointsRedeem). The Manifold Loyalty 2118 credits the merchant account (which may be an API function creditMerchantLoyaltyAccount (merchantLoyaltyAccountID, PointsRedeem). The Manifold Loyalty 2118 sends the point balance to the AdaptorRestController 2106. The AdaptorRestController 2106 sends the point balance to the electronic wallet application 2104 which in turn sends the point balance to the client 2102.

The process 2100 also involves aggregation and clearing. The AdaptorRestController 2106 sends an aggregateTransaction request to the AdaptorService 2108. The AdaptorService 2108 sends a runTransactionAggregationandClear( ) request to the Block chain service 2110. The AdaptorService 2108 sends a fetchUnprocessedTransaction request to the Manifold Loyalty 2118 which returns an unclearedTransactionList. The AdaptorService 2108 aggregates the unclearedTransactionList to a blockchain. For each uncleared transaction, the AdaptorService 2108 sends a request to transact the uncleared transaction (which may be an API function transact(unclearedTransaction) to the Block chain service 2110 which in turn sends the request to transact the uncleared transaction (which may be an API function transact(unclearedTransaction) to the reward contract 2112. The reward contract 2112 sends a success notification to the Block chain service 2110 which is relayed to the AdaptorService 2108. The AdaptorService 2108 runs a cleared transaction request. The AdaptorService 2108 sends a mark transaction processed request to the Manifold Loyalty 2118 (which may be an API function markTransactionProcessed (clearedTransactions)). The Manifold Loyalty 2118 sends a success notification to the AdaptorService 2108 which is relayed to the AdaptorRestController 2106.

An example API is Get Client Loyalty Transactions. This API is responsible to retrieve the client's loyalty transactions for certain criteria. Client can be enrolled in the merchant loyalty program and he has a loyalty card with the merchant. The banking cards and loyalty cards are stored in the electronic wallet application. Client can register the merchant with Linked loyalty program. Client loyalty balance for each merchant is maintained on the merchant platform, which is the system of record for this data element. Client loyalty balance for each merchant can be maintained on the Blockchain retail ledger (MLP).

This API will call AdaptorRestController to invoke the current Points bank (Manifold) to retrieve the total points balance for the client. The API can expose REST, with JSON payload and can include authentication.

The Get Client Loyalty Transactions can include the following example Request Parameters:

| ID | Element | Type | Description |
|---|---|---|---|
| 1 | Merchant Card | String | The identifier representing the loyalty |
| | Identifier | (16) | V the client |
| 2 | Criteria From | Date | The start date when to retrieve the |
| | date | | loyalty transactions. |
| | | | If not specified, this field will be |
| | | | considered 3 months before current date. |
| 3 | Criteria To | Date | The end date when to retrieve the |
| | Date | | loyalty transactions. |
| | | | If not specified, this field will be |
| | | | considered the current date. |

The Get Client Loyalty Transactions can include the following example Response Parameters:

| ID | Element | Type | Description |
|---|---|---|---|
| 1 | Transactions | List | The list of loyalty transactions for the client and |
| | List | | specified criteria. |
| | | | It can be empty, if no transactions are found. |
| | | | Each loyalty transaction will contain: |
| | | | Merchant name |
| | | | Parent transaction amount |
| | | | Number of points earned or redeemed |
| 2 | Status code | String (3) | The status code for this request: |
| | | | SUC = Success |
| | | | ERR = Error |
| 3 | Error reason | String | If the status code is ERR = Error, then the Error |
| | code | | reason code needs to contain the error code for |
| | | | failure, such as: |
| | | | General error |
| 1 | Points balance | Decimal | The total points balance for the client |
| 2 | Status code | String (3) | The status code for this request: |
| | | | SUC = Success |
| | | | ERR = Error |
| 3 | Error reason | String | If the status code is ERR = Error, then the Error |
| | code | | reason code needs to contain the error code for |
| | | | failure, such as: |
| | | | General error |

### Merchant Side Rewards API Specifications

The loyalty program includes Merchant side Rewards API specifications.

An example API is the Register Merchant with Loyalty platform. The API is responsible to onboard a new merchant into the loyalty platform, by creating merchant user credentials into the platform and creating the Blockchain ledger accounts. The API can create an account in the Retail ledger (Manifold) and another account in the Wholesale ledger (Block chain). The two accounts can be linked through the Merchant Smart contract.

The merchant can be assigned a merchant identifier, used for identifying its transactions. When the accounts are created the balances can be of 0.0 points. The Register Merchant with Loyalty platform API can call AdaptorService which is managing the entire transaction flow. The adaptor can also invoke: Provision merchant identities (user Id, password, merchant name) in the identity repository; Add merchant in the portal data store; Manifold services to create the merchant account on Manifold Retail ledger; Wallet service to create and store the Wallet details; BlockchainService which is the wrapper for smart contract implementation of Merchant contract; Wholesale ledger can add two accounts for the merchant: one in Merchant currency (MRC) and the other one in FI currency (FIRC). The API can expose REST, with JSON payload and can involve authentication.

The Register Merchant with Loyalty platform API can involve different example Request Parameters:

| ID | Element | Type | Description |
|---|---|---|---|
| 1 | User id | String | The merchant user identifier |
| | | (16) | |
| 2 | Password | String | The merchant user password for the platform |
| | | (10) | |
| 3 | Merchant | String | The name of the merchant registering with |
| | name | (25) | the loyalty platform |
| 4 | Merchant | String | The unique identifier for the merchant |
| | Identifier | (25) | |
| 5 | Merchant | String (8) | The specific merchant currency name |
| | Currency | | |

The Register Merchant with Loyalty platform API can involve different example Response Parameters:

| ID | Element | Type | Description |
|---|---|---|---|
| 1 | Status code | String (3) | The status code for this request: |
| | | | SUC = Success |
| | | | ERR = Error |
| 2 | Error reason | String | If the status code is ERR = Error, then |
| | code | | the Error reason code needs to contain |
| | | | the error code for failure, such as: |
| | | | General error |

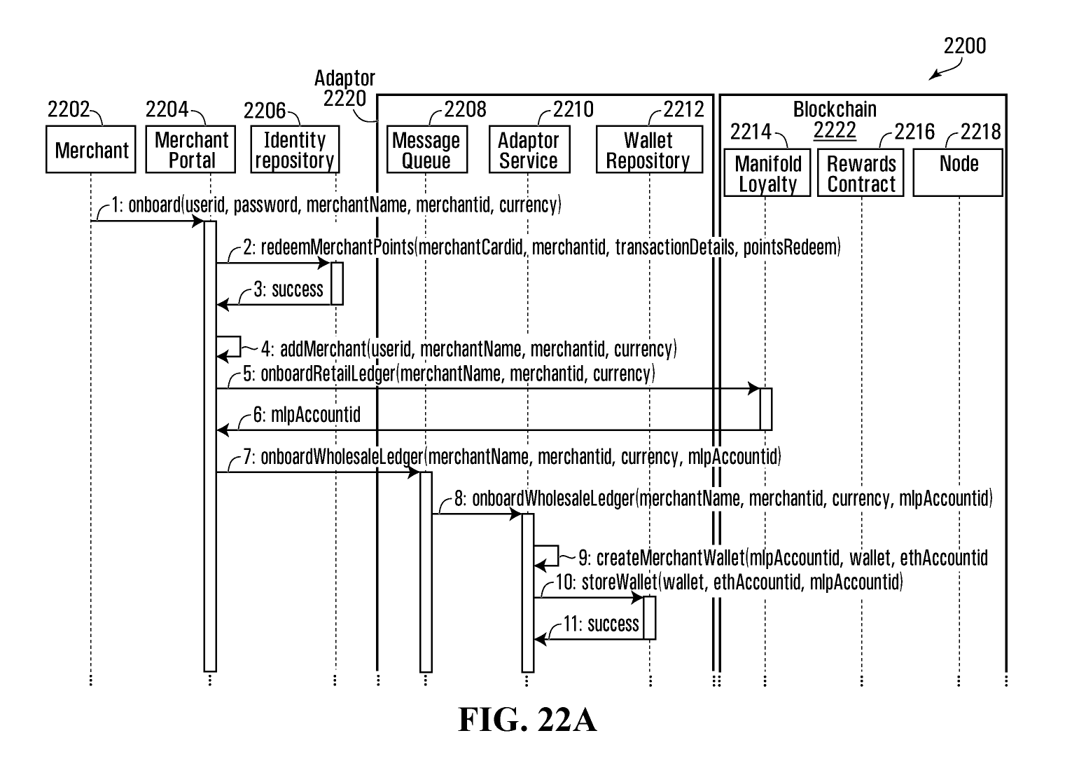

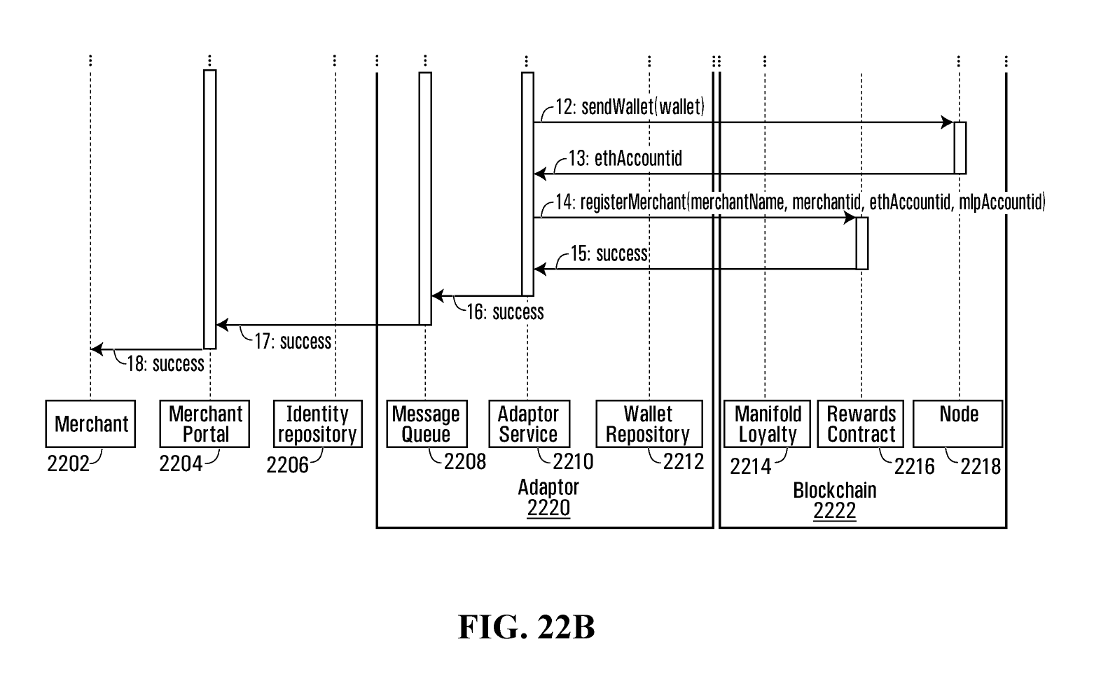

FIG. 22A and FIG. 22B shows an example process 2200 for loyalty programs.

Merchat 2202 sends an onboard request to merchant portal 2204 which can include data such as userID, password, merchantName, merchantID, currency (which may be an API function onboard(userID, password, merchantName, merchantID, currency). The merchant portal 2204 sends a request to add identities (which may be an API function addIdentities (userID, password, merchantName) to identity repository 2206. The identity repository 2206 sends a success notification to the merchant portal 2204. The merchant portal 2204 runs an add merchant request function (which may be an API function addMerchant (userID, merchantName, merchantID, currency)). The merchant portal 2204 sends an onboard retail ledger request to the Manifold loyalty 2214 (which may be an API function onboardRetailLedger (merchantName, merchantID, currency)). The Manifold loyalty 2214 sends an MLP account ID in response to the merchant portal 2204. The merchant portal 2204 sends an onboard wholesale ledger request to the message queue 2208 (which may be an API function onboardWholesaleLedger (merchantName, merchantID, currency, mlpAccountid)). The message queue 2208 sends an onboard wholesale ledger request to the AdapterService 2210 (which may be an API function onboardWholesaleLedger (merchantName, merchantID, currency, mlpAccountid)). The AdapterService 2210 runs a create merchant wallet function (which may be an API function createMerchantWallet (mlpAccountid): wallet, ethAccountID)). The AdapterService 2210 sends a store wallet request to the Wallet Repository 2212 (which may be an API function storeWallet (wallet, ethAccountID, mlpAccountid)). The Wallet Repository 2212 sends a success notification in response. The AdapterService 2210 sends a wallet node request to the Node 2218 (which may be an API function sendToWalletNode (wallet)). The Node 2218 sends a node account ID in response (NodeAccountID). The AdapterService 2210 a register merchant request to the Rewards Contract 2216 (which may be an API function registerMerchant (merchantName, merchantID, nodeAccountID, mlpAccountID). The Rewards Contract 2216 sends a success notification to the AdapterService 2210.

An example API is the Issue Merchant points in the Loyalty platform.

The Issue Merchant points in the Loyalty platform API can be responsible to issue a specified quantity of merchant points using their own currency, in their Wholesale ledger (blockchain) account. The merchant might be already onboarded and registered in the loyalty platform. The merchant might be already an assigned merchant identifier, used for identifying its transactions. The merchant might be authenticated into the platform. This API can be invoked by merchants (most likely, small merchant type) where they use FI platform as their own points bank, to provision their own currency and points program.

The merchant may have a DDA account opened with an FI, where he can pre-fund this account with cash (government backed currencies: USD, CAD). A debit to his DDA account, followed by the credit to his loyalty account in points amount (converted from CAD/USD) can take place.

In some embodiments, the new issued points can be propagated in the Retail ledger (MLP). The merchant may need to pre-fund a bank deposit account, before the points' issuance takes place in the ledger(s). This API can call AdaptorService for managing the entire transaction flow. The adaptor can also invoke: Wallet service to retrieve the Merchant block chain account. The BlockchainService which is the wrapper for smart contract implementation of Merchant contract. The BlockchainService can expose REST, with JSON payload, and can involve authentication.

The Issue Merchant points in the Loyalty platform can involve the following example Request Parameters:

| ID | Element | Type | Description |
|---|---|---|---|
| 1 | Merchant | String | The unique identifier for the merchant |
| | Identifier | (25) | |
| 2 | Points amount | Decimal | The number of points to be |
| | | | issued for the merchant |

The Issue Merchant points in the Loyalty platform can involve the following example Response Parameters:

| ID | Element | Type | Description |
|---|---|---|---|
| 1 | Points balance | Decimal | The new points balance of the |
| | | | merchant account, after the points |
| | were issued | | |
| 2 | Status code | String (3) | The status code for this request: |
| | | | SUC = Success |
| | | | ERR = Error |
| 3 | Error reason | String | If the status code is ERR = Error, |
| | code | | then the Error reason code needs |
| | | | to contain the error code for failure, |
| | | | such as: |
| | | | General error |

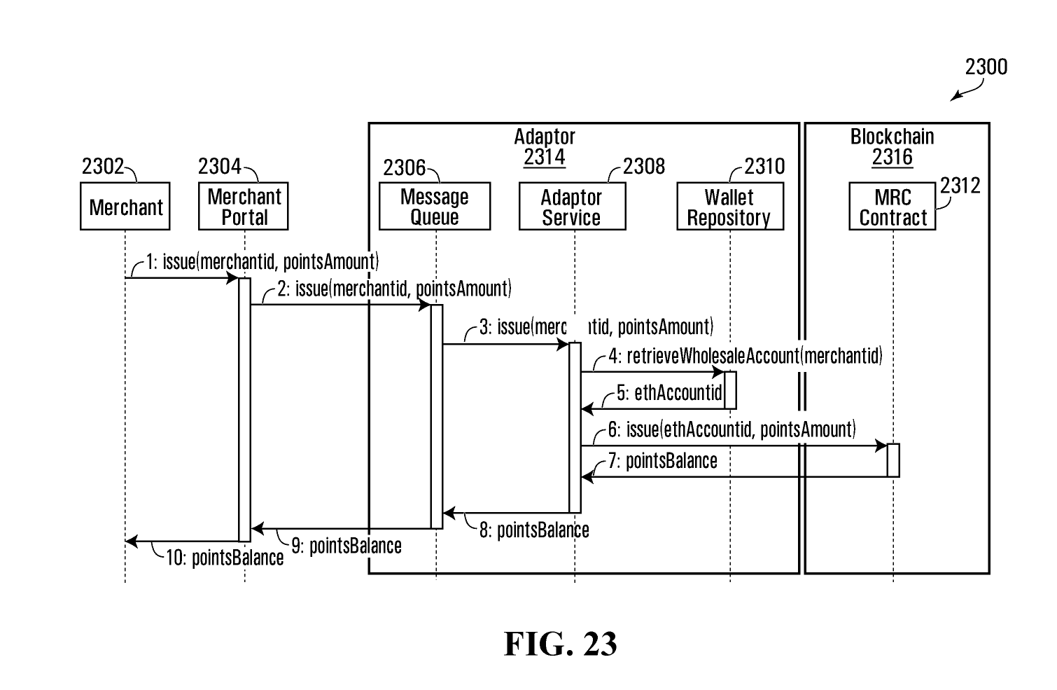

FIG. 23 illustrates a process 2300 with the Issue Merchant points in the Loyalty platform. The merchant 2302 sends an issue request to the merchant portal 2304 (which may be an API function issue (merchantID, pointsAmount). The merchant portal 2304 sends an issue request to the adaptor 2314 and in particular to the message queue 2306 (which may be an API function issue (merchantID, pointsAmount)). The message queue 2306 sends an issue request to the adaptor 2314 and in particular to the Adaptor Service 2308 (which may be an API function issue (merchantID, pointsAmount)). The Adaptor Service 2308 sends a retrieve message for the wholesale account to the Wallet Repository 2310 (which may be an API function Retrieve WholesaleAccount(merchantID)). The Wallet Repository 2310 returns the AccountID. The Adaptor Service 2308 sends an issue message to the MRC Contact 2312 of block chain 2316 (which may be an API function issue(accountID, pointsAmount)). The MRC Contact 2312 returns the points balance to the Adaptor Service 2308. The Adaptor Service 2308 returns the points balance to the message queue 2306 which sends it to the merchant portal 2304 and the merchant 2302.

An example API is the View Merchant balances.

The View Merchant balances API can be responsible to retrieve merchant points balances from the Wholesale Ledger (Ethereum) for both his own Merchant currency (MRC) and FI Rewards Currency (FIRC).

The merchant can be onboarded and registered in the loyalty platform. The merchant can have an assigned merchant identifier, used for identifying its transactions. The merchant has been authenticated into the platform.

This API can call AdaptorService for managing the entire transaction flow. The adaptor will also invoke: Wallet service to retrieve the Merchant Block chain account; BlockchainService which is the Java wrapper for smart contract implementation of Merchant contract. The API can REST, with JSON payload with authentication.

The API View Merchant balances can have the following example Request Parameters:

| ID | Element | Type | Description |
|---|---|---|---|
| 1 | Merchant | String | The unique identifier for the merchant |
| | Identifier | (25) | |

The API View Merchant balances can have the following example Response Parameters:

| ID | Element | Type | Description |
|---|---|---|---|
| 1 | Points balance | Decimal | The points balance of the merchant account, |
| | | | including both mrcPointsBalance and |
| | | | rrcPointsBalance |
| 2 | Status code | String (3) | The status code for this request: |
| | | | SUC = Success |
| | | | ERR = Error |
| 3 | Error reason | String | If the status code is ERR = Error, then the Error |
| | code | | reason code needs to contain the error code for |
| | | | failure, such as: |
| | | | General error |
| | | | Merchant balance can't be retrieved |

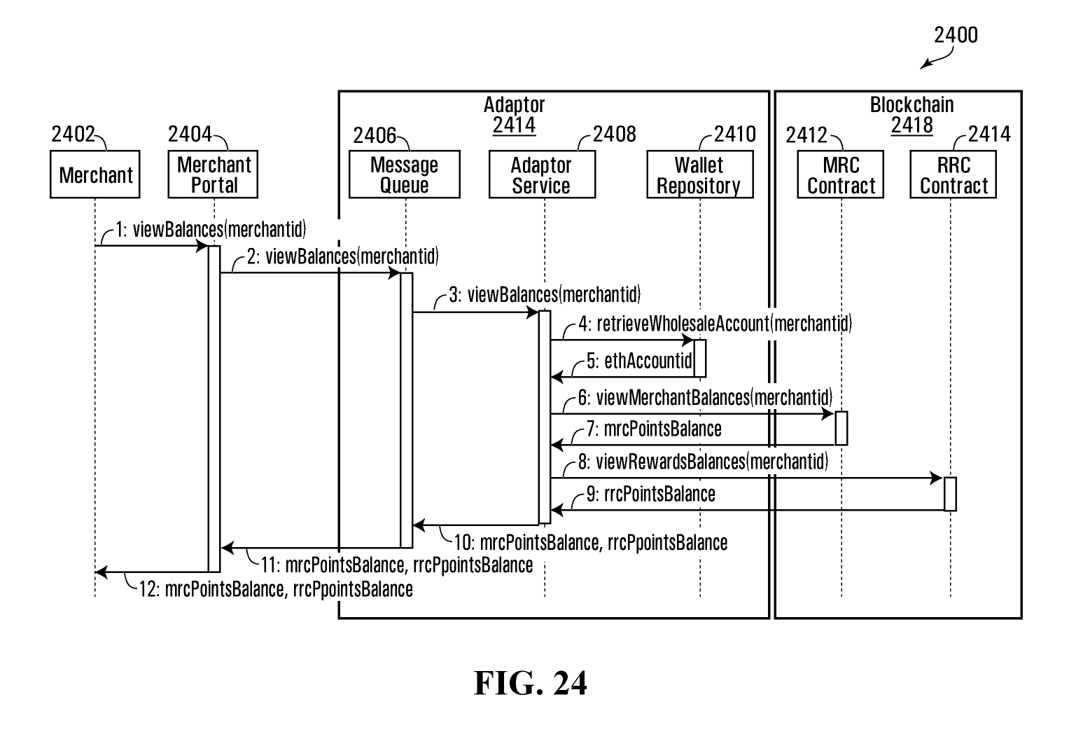

FIG. 24 is a process 2400 for the API View Merchant balances.

Merchant 2402 sends a view balance request (merchantID) to the merchant portal 2404. The merchant portal 2404 sends the view balance request (merchantID) to the message queue 2496 of the adaptor 2416 which in turn sends to the adaptor service 2408. The adaptor service 2408 sends a retrieve wholesale account request (merchantID) to the Wallet Repository 2410. The Wallet Repository 2410 sends the block chain AccountID to the Adaptor Service 2408. The Adaptor Service 2408 sends a view merchant balance request (merchant ID) to the MRC contact 2412 of the block chain 2418. The MRC contact 2412 returns the MRCPointsBalance. The Adaptor Service 2408 sends a view merchant balance request (merchant ID) to the FIRC contact 2414 of the block chain 2418. The FIRC contact 2414 returns the FIRCPointsBalance. The Adaptor Service 2408 sends MRCPointsBalance and the FIRCPointsBalance to the message queue 2406 and the merchant portal 2404 (and to merchant 2402).

An example API is Retrieve Merchant exchange rate.

The Retrieve Merchant exchange rate API can be responsible to retrieve the pre-established merchant exchange rate. The merchant can be an assigned merchant identifier, used for identifying its transactions. The merchant can be onboarded and registered in the loyalty platform. The merchant has been authenticated into the platform. There can be an exchange rate which has been assigned to this merchant by his financial institution (FI).

This API can call AdaptorService for managing the entire transaction flow. The adaptor will also invoke: Wallet service to retrieve the Merchant block chain account. The BlockchainService which is the wrapper for smart contract implementation of the Exchange contract. The API can expose REST, with JSON payload, and can involve authentication.

The API Retrieve Merchant exchange rate can have the following Request Parameters:

| ID | Element | Type | Description |
|---|---|---|---|
| 1 | Merchant | String | The unique identifier for the merchant |
| | Identifier | (25) | |

The API Retrieve Merchant exchange rate can have the following Response Parameters:

| ID | Element | Type | Description |
|---|---|---|---|
| 1 | Exchange rate | Decimal | The exchange rate established for the merchant. |
| 2 | Status code | String (3) | The status code for this request: |
| | | | SUC = Success |
| | | | ERR = Error |
| 3 | Error reason | String | If the status code is ERR = Error, then the Error |
| | code | | reason code needs to contain the error code for |
| | | | failure, such as: |
| | | | General error |
| | | | No exchange rate found for this merchant |

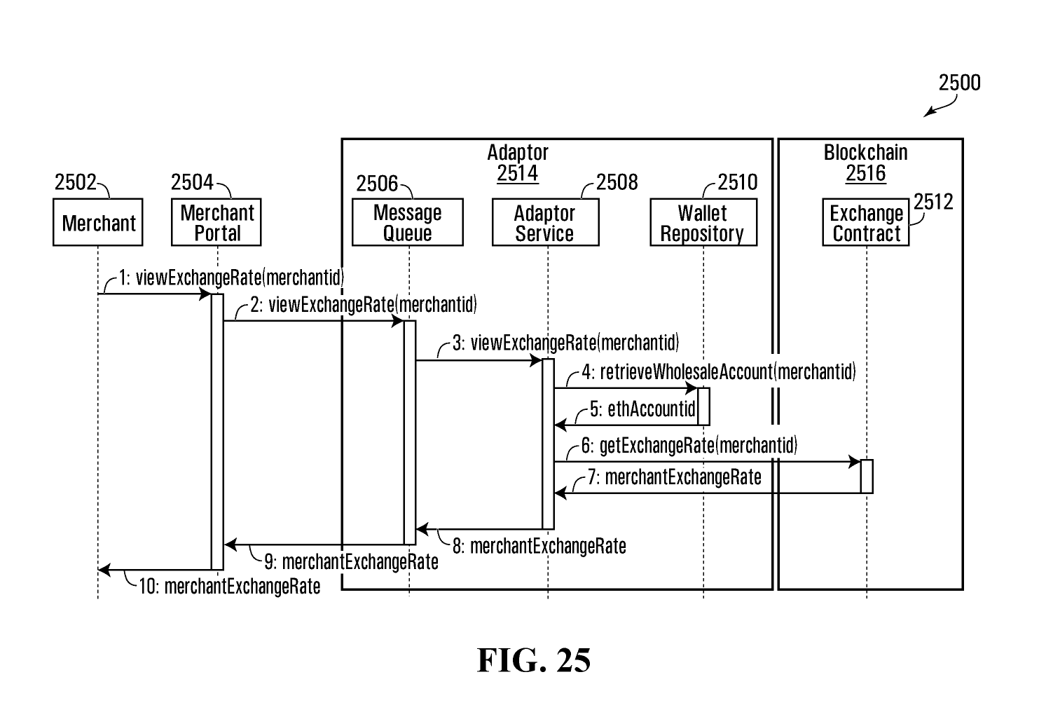

FIG. 25 is a process 2500 for the API Retrieve Merchant exchange rate. The merchant 2502 sends a view exchange rate (merchant ID) request to the Merchant Portal 2504. The Merchant Portal 2504 sends a view exchange rate (merchant ID) request to the message queue 2506 and then to the Adaptor Service 2508. The Adaptor Service 2508 sends a retrieve wholesale account (merchant ID) request to the Wallet Repository 2510 which returns a blockchain accountID. The Adaptor Service 2508 sends a getExchangeRate (merchant ID) to the exchange contract 2512 of the blockchain 2516. The exchange contract 2512 sends the merchant exchange rate to the Adaptor Service 2508 and onto the Message Queue 2506 and the merchant portal 2504 (and the merchant 2502).

An example API is the Exchange Merchant points in the Loyalty platform.

The Exchange Merchant points in the Loyalty platform API is responsible to exchange a specified quantity of merchant points to FI Rewards points. Before proceeding with the merchant points exchange, a balance check can be performed to ensure that the merchant has sufficient points in his wholesale ledger account (blockchain). An exchange rate for the merchant cna be retrieved before converting his merchant points (MRC—which is a general merchant currency) into FIRC points. The merchant can have an assigned merchant identifier, used for identifying its transactions. The merchant can be onboarded and registered in the loyalty platform. The merchant has been authenticated into the platform

The new issued points need to be propagated in the Retail ledger (MLP). The merchant needs to pre-fund a bank deposit account, before the points' issuance can take place in the ledger(s). The API can call AdaptorService for managing the entire transaction flow. The adaptor can also invoke: Wallet service to retrieve the Merchant blockchain account and the BlockchainService which is the wrapper for smart contract implementation of the Exchange contract. The API update the account balances as follows: In the Wholesale ledger: Debit Merchant account with MRC points; Credit FI account with MRC points; Retrieve conversion rate between MRC and FIRC for the merchant; Convert MRC to FIRC, with the conversion rate for the merchant; Debit RBC account with FIRC points; Credit Merchant account with FIRC points.

In the Retail ledger: Credit Merchant account with FIRC points to expose REST, with JSON payload and authentication.

The Exchange Merchant points in the Loyalty platform can have the following example Request Parameters:

| ID | Element | Type | Description |
|---|---|---|---|
| 1 | Merchant | String | The unique identifier for the merchant |
| | Identifier | (25) | |
| 2 | Merchant | Decimal | The number of merchant points which |
| | Points amount | | will be exchanged for RBC Rewards |
| | | | Currency (RRC). |

The Exchange Merchant points in the Loyalty platform can have the following example Response Parameters:

| ID | Element | Type | Description |
|---|---|---|---|
| 1 | Points balance | Decimal | The new points balance of the merchant |
| | | | account, after the points were issued |
| 2 | Status code | String (3) | The status code for this request: |
| | | | SUC = Success |
| | | | ERR = Error |
| 3 | Error reason | String | If the status code is ERR = Error, then |
| | code | | the Error reason code needs to contain |
| | | | the error code for failure, such as: |
| | | | General error |

The Client might have only one loyalty card for a specific merchant. The loyaltyID for the merchant loyalty card may get assigned by the merchant and it might be already provisioned to the client. Client points can be managed in the retail rewards ledger.

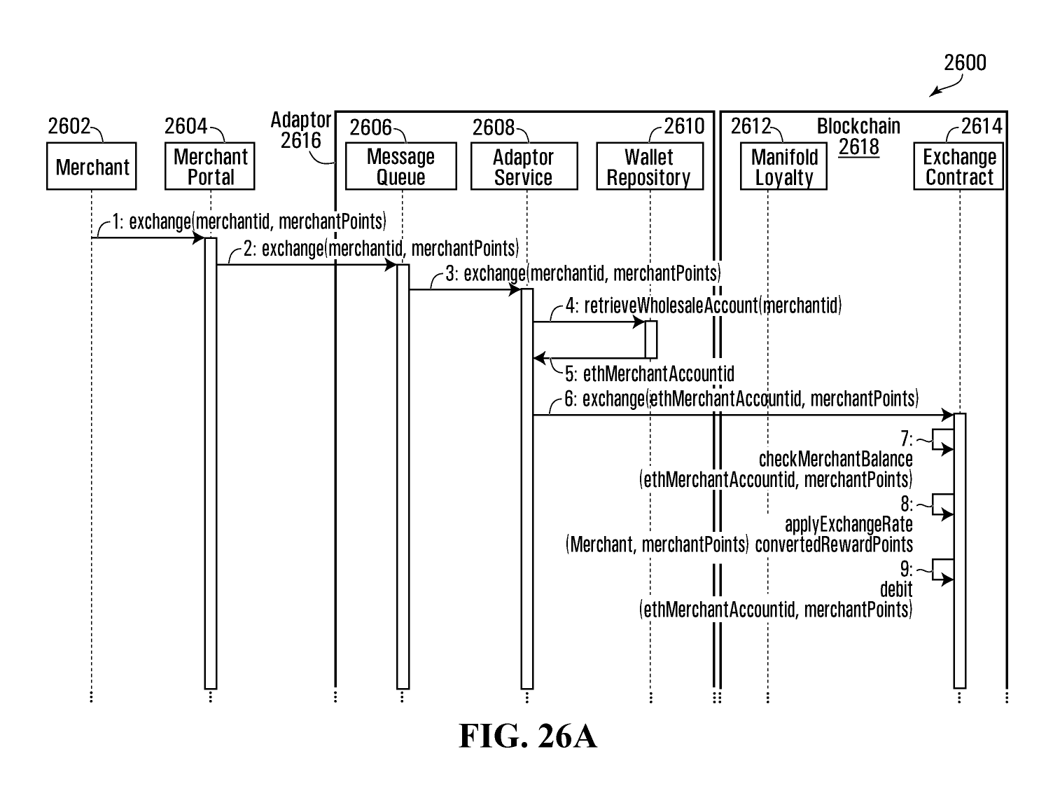

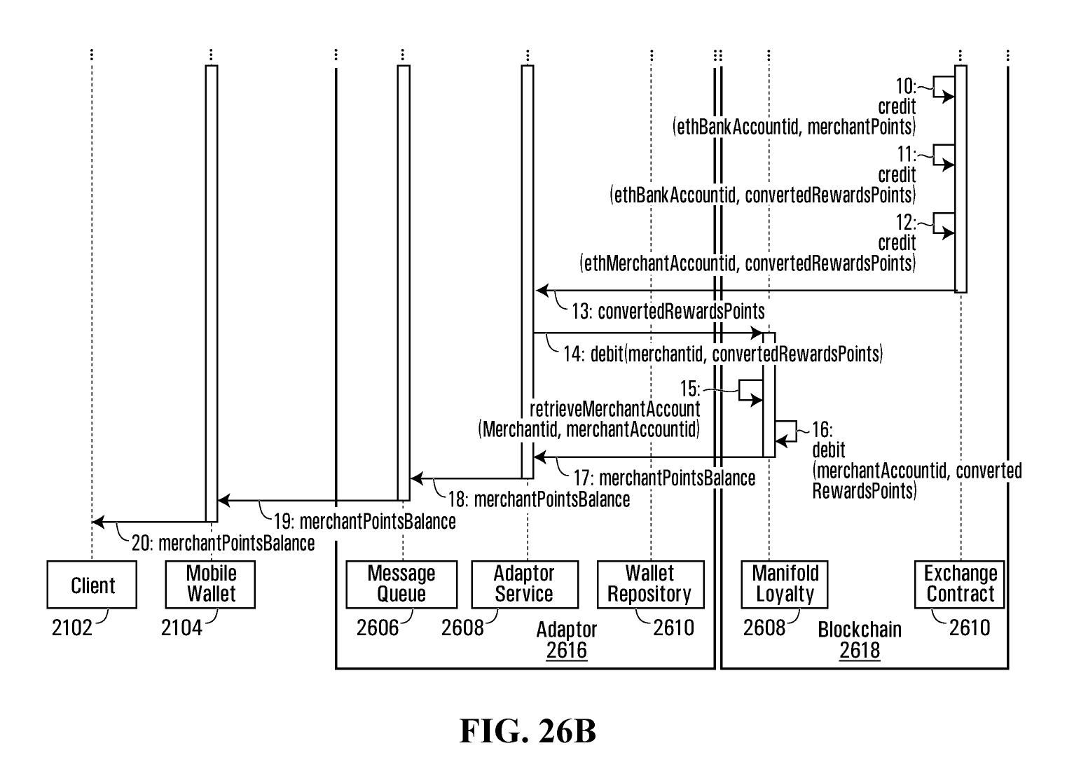

FIG. 26A and FIG. 26B shows a process 2600 for the Exchange Merchant points in the Loyalty platform.

The merchant 2602 sends an exchange request (merchantID, merchantPoints) to the merchant portal 2604 which sends the request to the adaptor 2616, and in particular the message queue 2606 and the Adapter Service 2608. The Adapter Service 2608 sends a retrieve wholesale account request (merchantID) to the Wallet Repository 2610 which returns the blockchainMerchantAccountID. The Adapter Service 2608 sends an exchange request (blockchainMerchantAccountID, merchantPoints) to the exchange contract 2614. The exchange contract 2614 runs a check balance (blockchainMerchantAccountID, merchantPoints) and applies an exchange rate (merchant, merchant points) converted FI rewards points. The exchange contract 2614 debits the merchant (blockchainMerchantAccountID, merchantPoints) and credits the blockchain bank account with the merchant points. The exchange contract 2614 credits the blockchain bank account with converted FI points. The exchange contract 2614 credits the merchant bank account with converted FI points. The exchange contract 2614 returns the converted FI rewards points. The Adaptor Service 2608 sends a debit request to the Manifold Loyalty 2612 (merchant ID, converted FI rewards points). The Manifold Loyalty 2612 retrieves the merchant account (merchantID): merchantAccountID. The Manifold Loyalty 2612 debits the merchant account ID with the converted FI rewards points. The Manifold Loyalty 2612 sends the merchant point balance to the Adaptor Service 2608 and onto the message queue 2606 and the merchant portal 2604 (and merchant 2602).

Program code is applied to input data to perform the functions described herein and to generate output information.

The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium.

For example, a server can include one or more computers operating as a web server, database server, or other type of computer server in a manner to fulfill described roles, responsibilities, or functions.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A computer-implemented system for blockchain transaction settlement, the system comprising:
a loyalty platform comprising:
a plurality of private nodes, each private node including at least one computing device and configured to maintain and update a distributed ledger for loyalty points management; and
an electronic wallet application having non-transitory computer-readable storage medium with computer-executable instructions for causing a processor of a mobile device to:
store an electronic loyalty card token, the token linked to a customer identifier;
receive a loyalty event notification indicating a loyalty event;
transmit the loyalty event notification and the customer identifier to the loyalty platform; and
the loyalty platform being configured to create a block for a loyalty transaction for the loyalty event notification using a private node, the block for the loyalty transaction indicating the customer identifier and the loyalty event, the loyalty platform being configured to maintain a loyalty account for the customer using the block.

2. The system of claim 1 wherein the loyalty platform is configured to maintain loyalty rules for calculating a loyalty point amount for the loyalty transaction for the loyalty event notification and store the loyalty point amount as part of the block for the loyalty transaction.

3. The system of claim 1 further comprising:
at least one communication interface between at least one of the plurality of nodes and at least one public node of a plurality of public nodes which maintain and update a public distributed ledger for clearing and settlement for transactions relating to loyalty points;
wherein the loyalty platform is configured to receive a clearing and settlement notification for a transaction notification from the public distributed ledger; and transmit the loyalty event notification to the electronic wallet application.

4. The system of claim 3 wherein the transaction notification is linked to a merchant identifier and the loyalty platform is configured to use the merchant identifier for generating the block.

5. The system of claim 1 wherein the loyalty event notification is linked to a merchant identifier and the loyalty platform is configured to use the merchant identifier for generating the block.

6. The system of claim 1 further comprising an adaptor for managing communications between the electronic wallet application and the loyalty platform, the communications involving at least one call to an application programming interface.

7. The system of claim 1 wherein the loyalty event is a earn event to earn loyalty points for a transaction, wherein the electronic wallet application is configured to: receive a transaction notification; wherein the loyalty platform is configured to receive a clearing and settlement notification for the transaction notification from the public distributed ledger; record an amount of loyalty points for the transaction notification as part of the block for the loyalty transaction.

8. The system of claim 1 wherein the electronic wallet application is configured to:
receive a view loyalty point balance request;
transmit a loyalty point balance request to the loyalty platform, the loyalty point balance request indicating the customer identifier;
receive a loyalty point balance for the customer identifier from the loyalty platform; and
initiate the display a loyalty point balance.

9. The system of claim 3 wherein the electronic wallet application is configured to:
transmit payment authorization for the transaction notification.

10. The system of claim 1 wherein the electronic wallet application is configured to:
transmit a view transaction history request to the loyalty platform, the loyalty point balance request indicating the customer identifier;
receive transaction history data from the loyalty platform, the transaction history data generate from data on a plurality of blocks from the distributed ledger for loyalty points management, each of the plurality of blocks linked to the customer identifier.

11. The system of claim 1 wherein the loyalty event is a redeem event to redeem a number of loyalty points, the block for the loyalty transaction indicating a debit operation for the number of points from the loyalty account for the customer.

12. The system of claim 1 wherein the loyalty event is an exchange event to exchange a number of loyalty points into another currency, the block for the loyalty transaction indicating an exchange operation based on a configured conversion rate for the number of loyalty points.

13. The system of claim 1 wherein the loyalty event is a transfer event to transfer a number of loyalty points from the loyalty account to a target loyalty account, the block for the loyalty transaction indicating a debit operation for the number of loyalty points from the loyalty account and a credit operation for the number of loyalty points to the target loyalty account.

14. The system of claim 1 wherein the loyalty platform is configured to generate a loyalty profile for the customer identifier, the loyalty profile having a loyalty point balance and a transaction history, the loyalty profile being linked to a plurality of blocks in the distributed ledger for loyalty points management, each of the plurality of blocks indicating the customer identifier, a loyalty event and an amount of loyal points.

15. The system of claim 1 wherein the block comprises smart contract code for computing an amount of loyalty points for the loyalty transaction, the block indicating the amount of loyalty points.

16. An electronic wallet application comprising a non-transitory computer readable medium for blockchain transaction settlement storing instructions which when executed by a processor:
store an electronic loyalty card token, the token linked to a customer identifier;
receive a loyalty event notification indicating a loyalty event;
transmit the loyalty event notification and the customer identifier to the loyalty platform; and
the electronic wallet application exchanging data or communication messages with an adaptor to a loyalty platform comprising:
a plurality of private nodes, each private node including at least one computing device and configured to maintain and update a distributed ledger for loyalty points management; and
the loyalty platform being configured to create a block for a loyalty transaction for the loyalty event notification using a private node, the block for the loyalty transaction indicating the customer identifier and the loyalty event, the loyalty platform being configured to maintain a loyalty account for the customer using the block.

17. The electronic wallet application of claim 16 wherein the loyalty platform is configured to maintain loyalty rules for calculating a loyalty point amount for the loyalty transaction for the loyalty event notification and store the loyalty point amount as part of the block for the loyalty transaction.

18. The electronic wallet application of claim 16 further comprising:
at least one communication interface between at least one of the plurality of nodes and at least one public node of a plurality of public nodes which maintain and update a public distributed ledger for clearing and settlement for transactions relating to loyalty points;
wherein the loyalty platform is configured to receive a clearing and settlement notification for a transaction notification from the public distributed ledger; and transmit the loyalty event notification to the electronic wallet application.

19. The electronic wallet application of claim 18 wherein the transaction notification is linked to a merchant identifier and the loyalty platform is configured to use the merchant identifier for generating the block.

20. The electronic wallet application of claim 16 wherein the loyalty event notification is linked to a merchant identifier and the loyalty platform is configured to use the merchant identifier for generating the block.

21. The electronic wallet application of claim 16 wherein the loyalty event is a earn event to earn loyalty points for a transaction, wherein the electronic wallet application is configured to: receive a transaction notification; wherein the loyalty platform is configured to receive a clearing and settlement notification for the transaction notification from the public distributed ledger; record an amount of loyalty points for the transaction notification as part of the block for the loyalty transaction.

22. The electronic wallet application of claim 16 configured to:
receive a view loyalty point balance request;
transmit a loyalty point balance request to the loyalty platform, the loyalty point balance request indicating the customer identifier;
receive a loyalty point balance for the customer identifier from the loyalty platform; and
initiate the display a loyalty point balance.

23. The electronic wallet application of claim 16 configured to:
transmit payment authorization for the transaction notification.

24. The electronic wallet application of claim 16 configured to:
transmit a view transaction history request to the loyalty platform, the loyalty point balance request indicating the customer identifier;
receive transaction history data from the loyalty platform, the transaction history data generate from data on a plurality of blocks from the distributed ledger for loyalty points management, each of the plurality of blocks linked to the customer identifier.

25. The electronic wallet application of claim 16 wherein the loyalty event is a redeem event to redeem a number of loyalty points, the block for the loyalty transaction indicating a debit operation for the number of points from the loyalty account for the customer.

26. The electronic wallet application of claim 16 wherein the loyalty event is an exchange event to exchange a number of loyalty points into another currency, the block for the loyalty transaction indicating an exchange operation based on a configured conversion rate for the number of loyalty points.

27. The electronic wallet application of claim 16 wherein the loyalty event is a transfer event to transfer a number of loyalty points from the loyalty account to a target loyalty account, the block for the loyalty transaction indicating a debit operation for the number of loyalty points from the loyalty account and a credit operation for the number of loyalty points to the target loyalty account.

28. The electronic wallet application of claim 16 wherein the loyalty platform is configured to generate a loyalty profile for the customer identifier, the loyalty profile having a loyalty point balance and a transaction history, the loyalty profile being linked to a plurality of blocks in the distributed ledger for loyalty points management, each of the plurality of blocks indicating the customer identifier, a loyalty event and an amount of loyal points.

29. The electronic wallet application of claim 16 wherein the block comprises smart contract code for computing an amount of loyalty points for the loyalty transaction, the block indicating the amount of loyalty points.

30. A computer-implemented system for blockchain transaction settlement, the system comprising:
a plurality of private nodes, each private node including at least one computing device and configured to maintain and update a private distributed ledger; and
at least one communication interface between at least one of the plurality of private nodes and at least one public node of a plurality of public nodes which maintain and update a public distributed ledger.

31. The system of claim 30, wherein at least one private node is configured for:
receiving from a device associated with at least one of the public nodes, via the at least one communication interface, a notification message identifying a transaction for posting;
monitoring at least one of the public nodes for an indication that the transaction has been cleared on the public distributed ledger; and
upon obtaining the confirmation that the transaction has been cleared on the public distributed ledger, generating signals to initiate propagation of the transaction to the plurality of private nodes.

32. The system of claim 30, wherein at least one private node is configured for:
receiving from a device associated with at least one of the private nodes, a notification message identifying a first transaction for posting;
sending a notification message identifying the first transaction for posting to a second device associated with at least one of the public nodes; and
generating signals to initiate propagation of the first transaction to the plurality of public nodes.

33. The system of claim 30, wherein the at least one private node is configured for:
receiving a second notification message identifying a second transaction for posting;
sending a notification message identifying the second transaction for posting to the second device associated with at least one of the public nodes; and
generating signals to initiate propagation of a batch transaction to the plurality of public nodes, the batch transaction including a combination of the first and the second transactions.
